(19) United States
(12) Patent Application Publication
(10) Pub. No.: US 2006/0196889 A1
(43) Pub. Date: Sep. 7, 2006

(54) FLUID STORAGE CONTAINER WITH PISTON PROVIDED INSIDE

(76) Inventor: Masatoshi Masuda, Kyoto (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/379,524

(22) Filed: Apr. 20, 2006

(51) Int. Cl. G01F 11/00

(52) U.S. Cl. 222/256; 222/386

(57) ABSTRACT

A fluid storage container includes a container main body 10 which stores fluid inside, a discharge outlet member 20 which is formed at the opening 11 which is formed on the container main body 10, a tube member 30 which has a flow path 31 which reaches the discharge outlet member 20 from the base of the container main body 10, and a piston member 40 which moves an inside cylinder within the container main body 10. This fluid storage container stores fluid in the space that is formed between the base of the container main body 10 and the piston member 40. In addition, this fluid storage container provides, within the discharge outlet member 20, an inflow valve structure 50 which flows in fluid that has been stored in the container main body 10 and an outflow valve structure 60 which flows out to the outside fluid that has been entered with the inflow valve structure 50.

### BACKGROUND OF THE INVENTION

1. Field of the Invention

The present invention generally relates to a fluid storage container which causes a fluid which was stored within a container's main body to flow out to the outside from a discharge member which is established at the opening part which was formed on top of the container's main body.

2. Description of the Related Art

This kind of fluid storage container is well-known as a container which is formed to allow fluid to flow out that has been stored inside by attaching to an opening neck an emptying pump as characterized in Japanese Patent Laid-open No. 2003-104416 (Patent reference 1). The invention in Patent reference 1 provides a container main body which stores the fluid and a slidable base wall 3 at the base of the container's main body. Because of this structure, according to the invention of Patent reference 1, even with a reduction in the fluid which is stored in the container's main body, by raising the base wall 3 upward, it is possible to prevent a reduction within the container's main body, and from this prevention, it is possible to prevent outside air from flowing inside the container's main body from the reduction in pressure within the container's main body.

### SUMMARY OF THE INVENTION

However, according to the invention in Patent reference 1, because the fluid is stored between the opening neck of the container's main body and the base wall 3, there is concern that the fluid will leak from the gap which is generated between the base wall 3 and the container main body's side wall 1 and thus be reduced. In addition, according to the invention of Patent reference 1, because the fluid is stored between the opening neck and the base wall 3, when air flows from the vicinity of the open neck, there is concern that the fluid that is stored and the air will make contact.

The present invention is constructed in order to solve at lease one of the previously described problems, and along with preventing fluid leaks, has an object of providing a fluid storage container which can prevent contact with outside air that has entered the inside of the container. The present invention can be practiced in various ways including, but not limited to, embodiments described below, wherein numerals used in the drawings are used solely for the purpose of ease in understanding of the embodiments which should not be limited to the numerals. Further, in the present specification, different terms or names may be assigned to the same element, and in that case, one of the different terms or names may functionally or structurally overlap or include the other or be used interchangeably with the other.

In an embodiment, the present invention provides a fluid storage container comprising: (i) a container main body (e.g., 10, 10′, 110) for storing fluid inside comprised of an opening section (e.g., 11, 11′, 111) formed on its top, a cylinder section (e.g., 12, 12′, 112) formed on its side, and a bottom section (e.g., 15, 15′, 115); (ii) a tube member (e.g., 30, 30′, 30″) immovably disposed inside the cylinder section and extending nearly from the bottom section to the opening section, inside which tube member constitutes a flow path (e.g., 31, 31′, 31″) for the fluid to flow therethrough via its lower end (e.g., 32, 32′, 32″) toward the opening section; and (iii) a piston member (e.g., 40, 40′, 140, 70, 70′, 170) disposed between the cylinder section and the tube member and being fluid-tightly slidable in an axial direction of the tube member toward the bottom section as the fluid between the piston and the bottom section outside the tube member moves into the tube member via the lower end of the tube member.

The above embodiment further includes, but is not limited to, the following embodiments:

The piston member may have an inner periphery (e.g., 47, 77) constituting a hole (e.g., 41, 71) through which the tube member is fluid-tightly inserted, and an outer periphery (e.g., 48, 78) fluid-tightly inserted in the cylinder section, said inner periphery and said outer periphery each having at least two fluid-tight portions (e.g., 42, 43, 44a, 44b; 44a′, 44b′, 72, 73, 74a, 74b: 74′, 74b′). The at least two fluid-tight portions of the inner periphery may comprise an upper fluid-tight portion (e.g., 43, 73) arranged at an upper edge part of the inner periphery and a lower fluid-tight portion (e.g., 42, 72) arranged at a lower edge part of the inner periphery; and the at least two fluid-tight portions of the outer periphery may comprise an upper fluid-tight portion (e.g., 44a, 44a′, 74a, 74a′) arranged at an upper edge part of the outer periphery and a lower fluid-tight portion (e.g., 44b, 44b′, 74b, 74b′) arranged at a lower edge part of the outer periphery. Each of the upper and lower fluid-tight portions of the inner periphery and the upper and lower fluid-tight portions of the outer periphery may comprise at least one annular convex portion. The at least one annular convex portion constituting the upper fluid-tight portion (e.g., 43, 73) of the inner periphery may more protrude inwardly than the at least one annular convex portion constituting the lower fluid-tight portion (e.g., 42, 72) of the inner periphery.

The inner periphery may have a length (e.g. L2) in an axial direction of the tube member, which is greater than a length (e.g., L1) of the outer periphery in the axial direction.

A lower edge (e.g., 44b, 44b′, 74b, 74b′) of the outer periphery may be less resilient in an inward radial direction perpendicular to an axial direction of the tube member than an upper edge (e.g., 44a, 44a′, 74a, 74a′) of the outer periphery in the inward radial direction.

The piston member may be formed from an elastic member and may have a lower surface (e.g., 76, 176) facing the bottom section extending from the inner periphery to the outer periphery, said lower surface being defined on a plane perpendicular to an axial direction of the tube member and having at least one concentric bending portion (e.g., 75, 175) to provide a biasing force in an outward radial direction toward the container main body.

The piston member may be slidable between the opening section and the bottom section. The piston member may be fixed to no part of the fluid storage container in an axial direction of the tube member between the opening section and the bottom section.

The fluid storage container may further comprise a discharge outlet member (e.g., 20, 200, 700, 700′) arranged on the container main body at the opening section and having a flow passage (e.g., 21, 201, 721) connected to the flow path of the tube member for flowing the fluid inside the container main body out to the outside. An inflow valve structure (e.g., 50, 500, 750, 950) for flowing the fluid from the tube member to the discharge outlet member may be provided in the flow path or the flow passage. The inflow valve structure may be arranged between the discharge outlet member and the tube member. The discharge outlet member may comprise an outflow valve structure (e.g., 60, 600, 770) for flowing the fluid to the outside which is arranged downstream of the inflow valve structure.

The fluid storage container may further comprise a pumping mechanism (e.g., 24, 900) disposed between the inflow valve structure and the outflow valve structure in the flow passage. The pumping mechanism may comprise a reciprocally movable linking pipe (e.g., 781, 782) and a piston (e.g., 783) coupled thereto in the flow passage for pumping the fluid from the tube member through the inflow valve structure out of the discharge outlet member through the outflow valve structure by reciprocal movement of the linking pipe and the piston. Alternatively, the pumping mechanism may comprise an expansion part (e.g., 24) which is elastically deformable and restorable in the flow passage for pumping the fluid from the tube member through the inflow valve structure out of the discharge outlet member through the outflow valve structure by reciprocally deforming and restoring the expansion part.

The cylinder section of the container main body may have an upper edge part having cutouts (e.g., 113) extending toward its upper edge.

In another aspect the present invention provides a piston member (e.g., 40, 40′, 140, 70, 70′, 170) configured to be fluid-tightly disposed between a cylinder member (e.g., 12, 12′, 112) and a tube member (e.g., 30, 30′, 30″) provided inside the cylinder member, comprising: (i) an inner periphery (e.g., 47, 77) constituting a hole (e.g., 41, 71) through which the tube member is to be fluid-tightly inserted; and (ii) an outer periphery (e.g., 48, 78) which is to be fluid-tightly inserted in the cylinder member, said inner periphery and said outer periphery each having at least two fluid-tight portions, wherein the inner periphery has a length (e.g., L2) in an axial direction of the piston member, which is greater than a length (e.g., L1) of the outer periphery in the axial direction.

The above embodiment further includes, but is not limited to, the following embodiments:

The at least two fluid-tight portions of the inner periphery may comprise an upper fluid-tight portion (e.g., 43, 73) arranged at an upper edge part of the inner periphery and a lower fluid-tight portion (e.g., 42, 72) arranged at a lower edge part of the inner periphery; and the at least two fluid-tight portions of the outer periphery may comprise an upper fluid-tight portion (e.g., 44a, 44a′, 74a, 74a′) arranged at an upper edge part of the outer periphery and a lower fluid-tight portion (e.g., 44b, 44b′, 74b, 74b′) arranged at a lower edge part of the outer periphery. Each of the upper and lower fluid-tight portions of the inner periphery and the upper and lower fluid-tight portions of the outer periphery may comprise at least one annular convex portion. The at least one annular convex portion (e.g., 43, 73) constituting the upper fluid-tight portion of the inner periphery may more protrude inwardly than the at least one annular convex portion (e.g., 42, 72) constituting the lower fluid-tight portion of the inner periphery.

A lower edge (e.g., 44b, 44b′, 74b, 74b′) of the outer periphery is less resilient in an inward radial direction perpendicular to an axial direction of the piston member than an upper edge (e.g., 44a, 44a′, 74a, 74a′) of the outer periphery in the inward radial direction.

The piston member may be formed from an elastic member and has a lower surface (e.g., 76, 176) facing the bottom section extending from the inner periphery to an outer periphery, said lower surface being defined on a plane perpendicular to an axial direction of the piston member and having at least one concentric bending portion (e.g., 75, 175) to provide a biasing force in an outward radial direction.

In all of the aforesaid embodiments, any element used in an embodiment can interchangeably be used in another embodiment unless such a replacement is not feasible or causes adverse effect. Further, the present invention can equally be applied to apparatuses and methods.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes.

FIG. 1 is a longitudinal sectional view of a fluid-storing container wherein the fluid-dispensing pump 1 according to Embodiment 1 of the present invention is applied.

FIG. 1 is a vertical cross-sectional diagram which shows the fluid storage container which is related to Embodiment 1 of this invention.

FIGS. 2(a)-2(c) are explanation diagrams which show the piston member 40. FIGS. 2(a), 2(b), and 2(c) are cross sectional view, top view, and bottom view, respectively.

FIGS. 3(a) and 3(b) are explanation diagrams which show the discharge opening member 20. FIGS. 3(a) and 3(c) are cross sectional view and front view, respectively.

FIGS. 4(a)-4(c) are explanation diagrams which show the valve member 61 which forms the outflow valve structure 60. FIGS. 4(a), 4(b), and 4(c) are cross sectional view, front view, and rear view, respectively.

FIGS. 5(a)-5(c) are explanation diagrams (cross sectional views) which show the outflow valve structure 60.

FIGS. 6(a)-6(c) are explanation diagrams which show the valve seat member 52 which forms the inflow valve structure 50. FIGS. 6(a), 6(b), and 6(c) are cross sectional view, top view, and bottom view, respectively.

FIGS. 7(a)-7(c) are explanation diagrams which show the valve member 51 which forms the inflow valve structure 50. FIGS. 7(a), 7(b), and 7(c) are cross sectional view, top view, and bottom view, respectively.

FIGS. 8(a) and 8(b) are explanation diagrams (cross sectional views) which show the inflow valve structure 50.

FIG. 9 is a vertical cross-sectional view of the fluid storage container which shows the state of discharging fluid that has been stored within the container main body 10 for the fluid storage container which is related to Embodiment 1.

FIG. 10 is a vertical cross-sectional view of the fluid storage container which shows the state of discharging fluid that has been stored within the container main body 10 for the fluid storage container which is related to Embodiment 1.

FIG. 11 is a vertical cross-sectional view of the fluid storage container which shows the state of discharging fluid that has been stored within the container main body 10 for the fluid storage container which is related to Embodiment 1.

FIG. 12 is a vertical cross-sectional view which shows the fluid storage container which is related to the Embodiment 2 of this invention.

FIGS. 13(a) and 13(b) are explanation diagrams which show the discharge opening outlet member 200. FIGS. 13(a) and 13(b) are cross sectional view and front view, respectively.

FIGS. 14(a)-14(c) are explanation diagrams which show the valve seat member 640 which forms the outflow valve structure 600. FIGS. 14(a), 14(b), and 14(c) are cross sectional view, front view, and rear view, respectively.

FIGS. 15(a)-15(c) are explanation diagrams which show the valve member 630 which forms the outflow valve structure 600. FIGS. 15(a), 15(b), and 15(c) are cross sectional view, front view, and rear view, respectively.

FIGS. 16(a)-16(c) are explanation diagrams (cross sectional views) which show the outflow valve structure 600.

FIGS. 17(a)-17(c) are explanation diagrams which show the valve seat member 540 which forms the inflow valve structure 500. FIGS. 17(a), 17(b), and 17(c) are cross sectional view, top view, and bottom view, respectively.

FIGS. 18(a)-18(c) are explanation diagrams which show the valve member 530 which forms the inflow valve structure 500. FIGS. 18(a), 18(b), and 18(c) are cross sectional view, top view, and bottom view, respectively.

FIGS. 19(a) and 19(b) are explanation diagrams (cross sectional views) which show the inflow valve structure 500.

FIG. 20 is a vertical cross-sectional view which shows a fluid storage container which is related to Embodiment 3 of this invention.

FIG. 21 is a vertical cross-sectional view of the discharge outlet member 700 including the fluid discharge pump 900 which shows the conditions for discharging the fluid that was stored within the container main body 10′ which forms the fluid storage container which is related to Embodiment 3.

FIG. 22 is a vertical cross-sectional view of the discharge outlet member 700 including the fluid discharge pump 900 which shows the conditions for discharging the fluid that was stored within the container main body 10 which forms the fluid storage container which is related to Embodiment 3.

FIG. 23 is a vertical cross-sectional view of the discharge outlet member 700 including the fluid discharge pump 900 which shows the conditions for discharging the fluid that was stored within the container main body 10′ which forms the fluid storage container which is related to Embodiment 3.

FIG. 24 is a vertical cross-sectional view of the fluid storage container which shows the conditions for discharging fluid there was stored within the container main body 10′ for the fluid storage container which is related to Embodiment 3.

FIG. 25 is a vertical cross-sectional view of the fluid storage container which shows the conditions for discharging fluid there was stored within the container main body 10′ for the fluid storage container which is related to Embodiment 3.

FIG. 26 is a vertical cross-sectional view of the fluid storage container which shows the conditions for discharging fluid there was stored within the container main body 10′ for the fluid storage container which is related to Embodiment 3.

FIG. 27 is a vertical cross-sectional view which shows the fluid storage container which is related to Embodiment 4 of this invention.

FIGS. 28(a)-28(c) are explanation diagrams which show the piston member 70. FIGS. 28(a), 28(b), and 28(c) are cross sectional view, top view, and bottom view, respectively.

FIG. 29 is an explanation diagram which shows the base of the container main part 10 when there is slanting of the base of the container main body 100 and the base surface of piston member 170.

FIG. 30 is an explanation diagram which shows the state of filling the fluid and the container main body 104 a fluid storage container which is related to Embodiment 5 of this invention.

FIG. 31 is an explanation diagram which shows the fluid storage container which is assembled by selecting the container main body 100 and the piston member 70.

FIG. 32 is an explanation diagram which shows a cross section of the piston member 40′.

FIG. 33 is an explanation diagram which shows a cross section of the piston member 70′.

Explanation of the Symbols: 10, 10′—container main body; 1′—opening; 12—cylinder; 13—aeration hole; 14—male screw; 15—bottom section; 20—discharge outlet member; 21—flow passage; 22—female screw; 23—rib; 24—expansion part; 30—tube member; 31—flow path; 32—lower end; 40, 40′—piston member; 41—hole; 42—liquid tight part; 43—liquid tight part; 44a, 44b, 44a′, 44b′—liquid tight part; 47—outer periphery; 48—inner periphery; 50—inflow valve structure; 51—valve member; 52—valve seat member; 60—outflow valve structure; 61—valve member; 70—piston member; 71—hole; 72—liquid tight part; 73—liquid tight part; 74—liquid tight part; 75—bending part; 100—container main body; 110—container lower part; 111—end; 112—cylinder; 113—notch; 120—container upper part; 121—opening; 123—aeration hole; 124—male screw; 200—discharge outlet member; 201—flow passage; 202 female screw; 203—join part; 204—expansion part; 500—inflow valve structure; 511—valve; 512—axis; 513—sliding part; 521—join part; 522—inner wall; 523—rib; 524—joiner; 530—valve member; 531—valve; 532—link part; 533—bend part; 534—support; 540—valve seat member; 541—hole; 542—joiner; 543—joiner; 544—join; 600—outflow valve structure; 611—valve; 612—axis; 613—join; 630—valve member; 631—valve; 632—link part; 633—bend part; 634—support; 640—valve seat member; 641—hole; 642—joiner; 643—convex part; 700—discharge outlet member; 723—cylinder; 724—coil spring; 750—inflow valve structure; 752—valve member; 760—intermediate valve structure; 770—valve member; 781—1^{st} linked pipe; 782—2^{nd} linked pipe; 783—piston; 791—opening; 800—nozzle head; 810—outer cover; 900—fluid discharge pump; 923—cylinder; 950—inflow valve structure; 952—valve member.

### DETAILED DESCRIPTION OF THE PREFERRED EMBODIMENT

The present invention will be explained with respect to preferred embodiments and drawings. However, the preferred embodiments and drawings are not intended to limit the present invention.

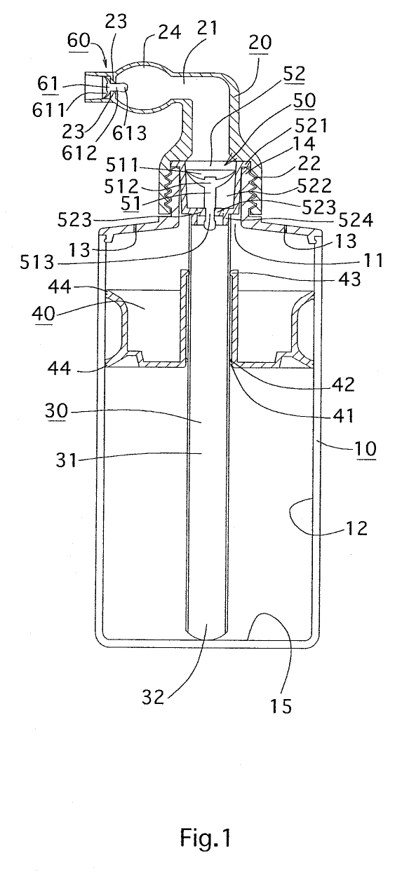

Below, there is an explanation of the fluid storage container which is related to Embodiment 1 of this invention based on the drawings, and FIG. 1 is a vertical cross-sectional view which shows the fluid storage container which is related to Embodiment 1 of this invention. This fluid storage container is used as a container for cosmetics for storing gel such as hair gel or cleansing gel which is used in the beauty field or créme products such as nourishing créme or massage cream or for liquids such as face lotion. Moreover, it is permissible to use this fluid storage container as a container of general drugs or solvents or food products. In this specification, highly viscous liquids or semifluids or sols are called fluids which contain ordinary fluids such as jelly-shaped solidified gels or créme-shaped substances.

This fluid storage container provides an opening section 11 on top, a cylinder section 12 which is formed on the side surface, and there is provided a container main body 10 which stores the fluid inside, a discharge outlet member 20 which is established at the opening outlets section 11 which is formed on the container main body 10, and a tube member 30 which has a flow path 31 which reaches the discharge outlet member 20 of the base of the container main body 10 and there is provided a piston member 40 which moves inside the cylinder section 12 in the container main body 10. A lower end 32 of the tube member 30 is disposed in the vicinity of (can be in contact with) a bottom section 15 of the container main body 10. The lower end 32 of the tube member 10 has an angled edge so that the fluid in the container main body 10 can flow into the tube member 10.

From this kind of structure, it is possible for this fluid storage container to store fluid in the space which is formed between the base of the container main body 10 and the piston member 40. In addition, this fluid storage container provides, on the inside of the discharge outlet member 20, an inflow valve structure 50 which flows in the fluid that is stored in the container main body 10 which is explained in detail later, and an outflow valve structure 60 which flows out to the outside the fluid that flowed in to the inflow valve structure 50 which is explained in detail later.

In the vicinity of the opening 11 of the container main body 10, there is a plurality of holes that are formed in order to take in outside air in the space which is formed between the opening 11 of the container main body 10 and the piston member 40. In addition, on the outer circumferential section of the opening of the container main body 10, there is formed a male thread 14 which Joins with the discharge outlet member 20 which is explained in detail later.

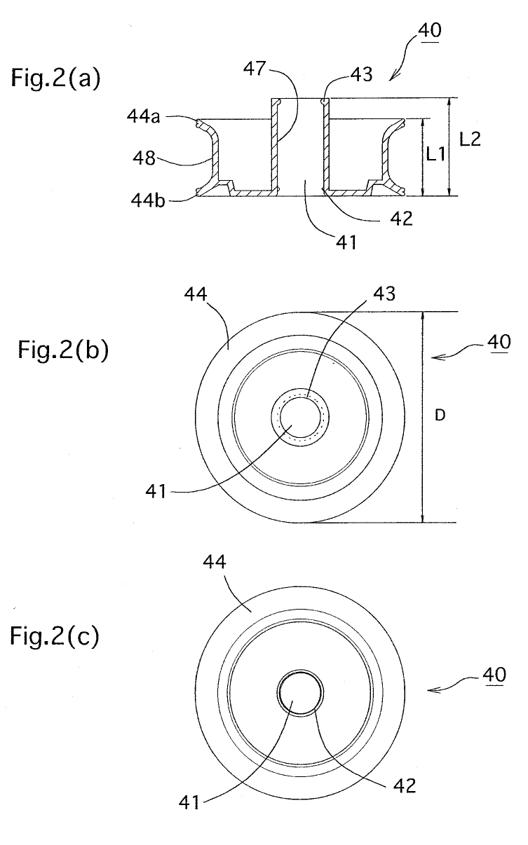

FIGS. 2(a)-2(c) are explanation diagrams which explain the piston member 40. In these views, FIG. 2(a) is a vertical cross-sectional view of the piston member 40 and FIG. 2(b) is a front view. In addition, FIG. 2(c) is a base surface view.

A hole 41 which passes through a tube member 30 is formed on the piston member 40. A liquid tight part 44a/44b of convex shape which is connected with the cylinder section 12 of the container main body 10 is formed on the upper and lower parts of the outer circumferential surface of this piston member 40. The liquid tight part 44a/44b which is formed on the upper part and the lower part is arranged at locations that are separated by fixed distances. In addition, the liquid tight part 42 of convex shape which makes contact with the tube member 30 is formed on the lower parts of the inside of the hole 41 of this piston member 40, and the liquid tight part 42 of convex shape which makes contact with the tube member 30 is formed. The upper part of the liquid tight part 43 projects inward more than the liquid tight part 42 of the lower part. Because of this, even when there is a larger elastic restoring force in the direction of the tube member 30 to the lower part in the piston member 40, it is possible to connect the upper part of the liquid tight part 43 and the tube member 30. From this connection, it becomes possible to prevent the liquid that was stored in the space that was formed between the base of the container main body 10 and the piston member 40 from entering the space which is formed between the opening 11 of the container main body 10 and the piston member 40.

Moreover, the liquid tight parts 42, 43, 44a, and 44b which are formed on the piston member 40 are not limited to being formed at the top part or the bottom part, and may be formed at the center, and in addition, it is permissible to form a plurality of two or more. In addition, the liquid tight parts 43, 44a, and 44b which are formed on the piston member are not limited to being formed at locations which respectively correspond.

The liquid tight parts 42 and 43 are formed on the inner periphery 47 and inwardly project. The liquid tight parts 44a and 44b are formed on the outer periphery 48 and outwardly project. Each liquid tight part may comprise on its tip at least one annular convex portion which projects in a direction substantially or nearly perpendicular to an axial direction of the piston member 40. Each convex portion may have a symmetrical cross section with respect to a direction perpendicular to an axial direction of the piston member, and may have a semicircular, triangular, polygonal, U-shaped, or V-shaped cross section. The contact area of the convex portion against an inner circumferential surface of the cylinder section or an outer circumferential surface of the tube member can remain small (line contact) even if pressure is exerted toward the circumferential surface, so that a seal between the convex portion and the circumferential surface can become tight (thereby accomplishing high liquidtightness) while the piston member can slide smoothly against the inner circumferential surface of the cylinder section and the outer circumferential surface of the tube member. The convex portion may have a protrusion height of 0.01-2.0 mm, typically 0.1-1.0 mm. The piston member may be made of polypropylene or polyethylene, or resin such as silicone rubber.

When the liquid tight part such as the liquid tight parts 44a and 44b has a pair of convex portions arranged adjacently, liquidtightness performance can be doubled while a contact area of the piston member and the inner circumferential surface of the cylinder section remains small. The size or protrusion height of the convex portion of the liquid tight part 43 may be 1.1 to 3 times (e.g., 1.3 to 2 times) greater than the convex portion of the liquid tight part 42 so that a seal at the liquid tight part 43 can be enhanced while movability of the piston member remains adequate. Even if a leak occurs at the liquid tight part 42, a leak can effectively be prevented at the liquid tight part 43. Further, if the height of the convex portion of the liquid tight part 43 is higher than that of the liquid tight part 42, a seal at the liquid tight part 42 can also be enhanced (e.g., when one end of a free cylinder is forced to expand, the other end of the cylinder tends to contract). The liquid tight parts 42, 43, 44a, and 44b can have different convex portions in terms of the number of the convex portions, the cross sectional shapes, the height of the convex portions, etc.

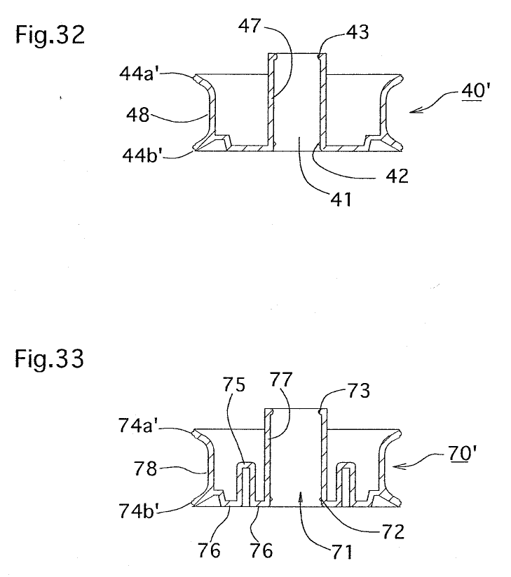

The outer periphery 48 may have an arched vertical cross section as shown in FIG. 2(a). In FIG. 2(a), the liquid tight parts 44a and 44b each comprise two convex portions. However, as shown in FIG. 32, the liquid tight parts 44a′ and 44b′ can each be constituted by a single convex portion. The number or size of convex portion of each liquid tight part (42, 43, 44a, 44b, 44a′, 44b′) can be different. For example, the liquid tight part 44b can have two convex portions, whereas the liquid tight part 44a can have one convex portion which is larger than the convex portion of the liquid tight part 44b, and vice versa.

For smooth movement with high liquidtightness, the inner periphery 47 may have a length L2 which is greater than a length L1 of the outer periphery 48, e.g., by about 5% to about 50% (including about 10% to about 30%) of L1, in the axial direction of the piston member 40.

Further, the length L1 of the outer periphery 48 may be smaller than a diameter D of the outer periphery 48. In an embodiment, the length L1 of the outer periphery 48 may be less than 50% of the diameter D of the outer periphery 48.

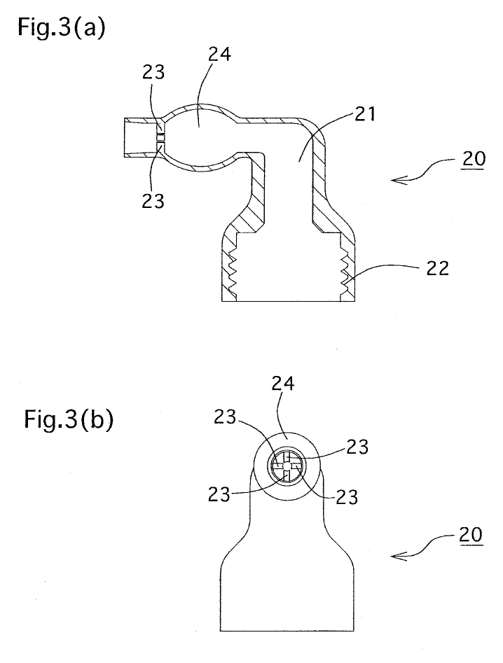

FIGS. 3(a) and 3(b) are explanation diagrams which show the discharge outlet member 20. FIG. 3(a) is a vertical cross-sectional view of the discharge outlet member 20, and FIG. 3(b) is a left side surface view.

The discharge outlet member 20 is formed from an elastic member which has a flow passage 21 for flowing out to the outside fluid that was stored within the container main body 10. A male thread 22 is formed at the side of the container main body 10 of the flow path 21 at this discharge outlet member 20. This male thread 22 threads together the male thread 14 which was formed on the outside of the opening 11 of the container main body 10. In addition a plurality of ribs is formed at the end of the discharge side for the fluid in the flow path 21 at this discharge outlet member 20. This rib part 23 forms one parts of the outflow valve structure 60, and supports the movement of the valve member 61 which will be explained in detail later. Furthermore, between the male thread 22 of the flow path 21 at this discharge outlet member 20 and the rib part 23 forms an expansion part 24. This expansion part 24 is closely formed. From this, there's contraction of the width of a flow passage 21 by pressure, and when canceling the pressure from the outside, by an elastic restoring force of the discharge outlet member 20, it is possible to reduce the pressure inside the flow passage 21.

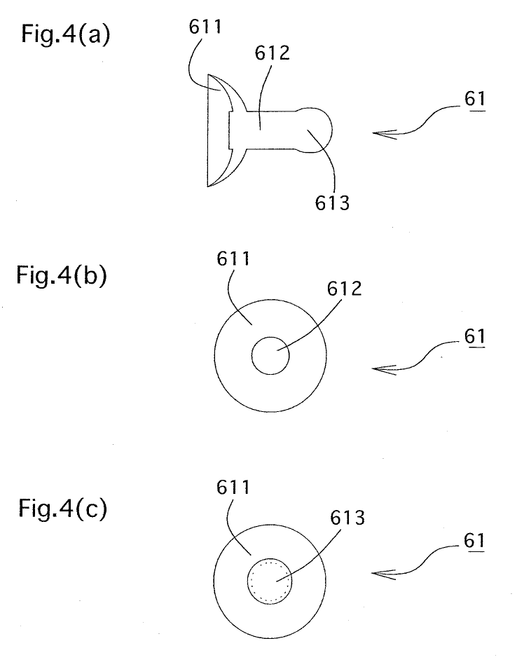

FIGS. 4(a)-4(c) are explanation diagrams which show the valve member 61 which forms the outflow valve structure 60. Among these diagrams, FIG. 4(a) is a vertical cross-sectional view of the valve member 61 and FIG. 4 (b) is a left side surface view. In addition FIG. 4 (c) is a right side surface view.

The outer circumferential surface of the valve member 61 is formed from an elastic member which provides a bowl-shaped valve 611 which is contactable with the inner surface of the flow path 21 at the discharge outlet member 20, an axis 612 which is established from the approximate center of the valve 611, and a latch which is positioned on the reverse side with the valve 611 of the axis 612.

The valve 611 is closely formed. Because of this, when there is pressure to the left side from the right side, the outer circumferential surface contracts, and there is separation from the inner surface of the flow path 21. On the other hand, when the pressure from the right side to the left side is eliminated, or when the pressure to the right side from the left side is biased, this outer circumferential surface is restored or expands, and makes contact with the inner surface of the flow path 21.

The axis 612 is formed to such a shape as to be slidable onto the rib 23 which is formed on the discharge outlet member 20. The sliding of the rib 23 of this axis 612 is controlled by the valve 611 and latch 613.

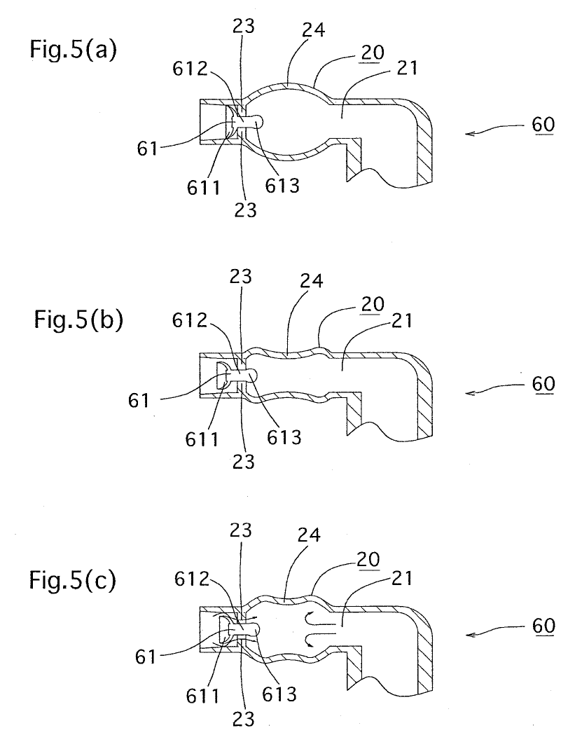

FIGS. 5(a)-5(c) are explanation diagrams which show the outflow valve structure 60. Among these views, FIG. 5(a) shows a closed state for the outflow valve structure 60, FIG. 5 (b) shows a release condition, and FIG. 5 (c) shows the state while returning to a closed condition from a released condition.

The outflow valve structure 60 is formed from the rib 23 at the valve member 61 at the discharge outlet member 20. When this outflow valve structure 60 spontaneously releases, as shown in FIG. 5(a), the outer circumferential surface of the valve 611 for the valve member 61 becomes closed which makes contact with the inner surface of the flow path 21 at the discharge outlet member 20. The outflow valve structure 60 prohibits the passage of fluid between the inside and outside when in a closed state.

When this outflow valve structure 60 has a biasing force to the outside from the inside, as shown in FIG. 5 (b), the axis 612 for the valve member 61 moves until controlled by this latch 613 in an outward direction relative to the rib 23 at the discharge outlet member 20. The outer circumferential surface of the valve 611 at the valve member 61 contracts, and there is separation from the inner surface of the flow path 21. Because of this, the outflow valve structure 60 can have flow of fluid between the inside and the outside in this release state.

When the pressing force for the inside to the outside is eliminated with this outflow valve structure 60, or when the pressing force to the inside from the outside is biased, as shown in FIG. 5 (c), the outer circumference of the valve 611 for the valve member 61 expands, and makes contact with the inner surface of the flow path 21. From this, the outflow valve structure 60 in this state once again restricts flow of fluid between the inside and the outside. Until the axis 612 of the valve structure 61 is controlled by this valve 611, there is relative movement to the inside with respect to the rib 23 at the discharge outlet member 20.

Moreover, it is not necessary for the valve 611 of the valve member 61 which forms this outflow valve structure to be positioned on the discharge side from the rib 23, and this valve 611 may be positioned on the inside from the rib 23.

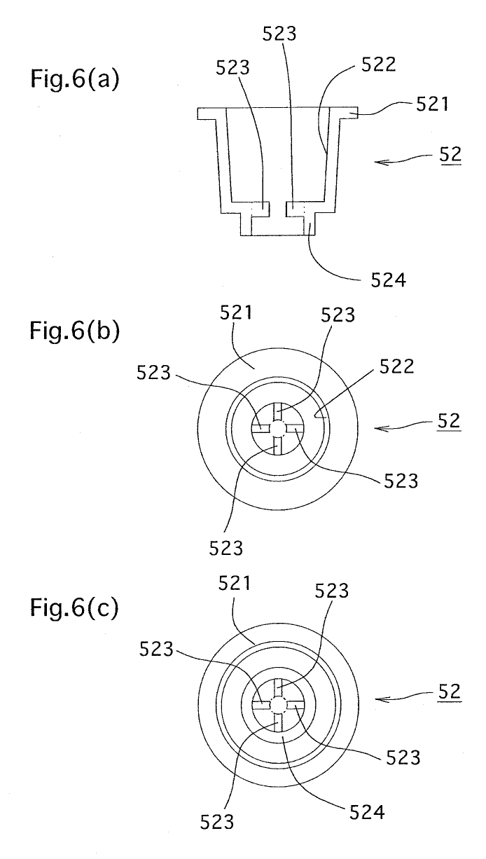

FIGS. 6(a)-6(c) are explanation diagrams which show the valve seat member which forms the inflow valve structure 50. Among these diagrams, FIG. 6(a) is a vertical cross-sectional view of the valve seat member 52 and FIG. 6(b) is a top surface view. In addition, FIG. 6(c) is a base surface view.

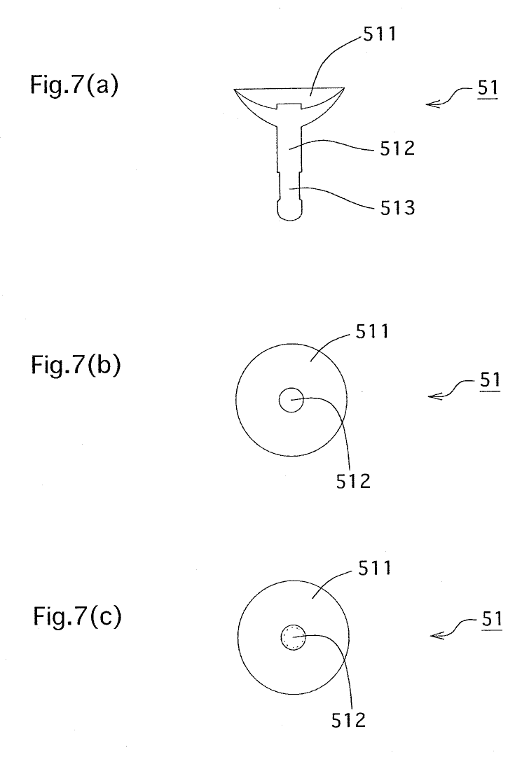

The valve seat member 52 provides a join part 521 for securing to the discharge outlet member 20 by sandwiching between the container main body 10 and the discharge outlet member 20, a tubular-shaped inner wall 522, a plurality of ribs 523 which slidably support a sliding part 513 (reference FIGS. 7(a)-7(c)) on the valve member 51 which is explained later in detail, and a join 524 which connects with the upper end of the tube member 30.

FIGS. 7(a)-7(c) are explanation diagrams which show the valve member 51 which forms the inflow valve structure 50. Among these diagrams, FIG. 7(a) is a vertical cross-sectional view of the valve member 51 and FIG. 7(b) is a top surface view. In addition, FIG. 7(c) is a base surface view.

The outer circumferential surface of the valve member 51 is formed from an elastic member which provides a bowl-shaped valve 511 which is connectable with the inner wall 522 of the valve seat member 52, an axis 512 which is placed from approximately the center of the valve 511, and a slide part 513 which slidably supports the rib 523 of the valve seat member 52 by being positioned at approximately the center of the axis 512.

The valve 511 is closely formed. Because of this, when the pressure in the upward direction from the downward direction is biased, the outer circumferential surface contracts, and there is separation from the inner wall 522 of the valve seat member 52. On the other hand, when the pressure is upward from downward is eliminated, or the pressure downward from upward is biased, the outer circumferential surface is restored or expands, and makes contact with the inner wall 522 of the valve seat member 52.

The slide part 513 is formed as a slidable shape with the rib 523 which is formed on the valve seat member 52. Sliding on the rib 523 of this slide part 513 is controlled by the top end and bottom end of the slide part 513.

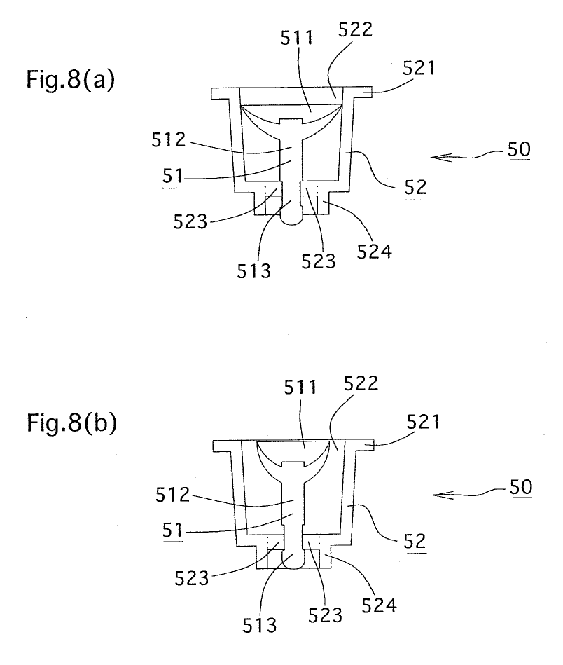

FIGS. 8(a) and 8(b) are explanation diagrams which show the inflow valve structure 50. Among these diagrams, FIG. 8(a) shows the closed condition for the inflow valve structure 50, and FIG. 8(b) shows its open state.

The inflow valve structure 50 is formed by the valve seat member 52 and the valve member 51. For this inflow valve structure 50, when spontaneously released, as shown in FIG. 8(a), the outer circumferential surface of the valve 511 on the valve member 51 enters a closed state which makes contact with the inner wall 522 of the valve seat member 52. The inflow valve structure 50 prohibits the flow of fluid between the outside and the inside of the container main body 10 in this closed condition.

When the suppressing force directed to the outside from the inside of the container main body 10, for this inflow valve structure 50, is biased, as shown in FIG. 8(b), the slide 513 for the valve member 51 moves in the outside direction of the container main body 10 relative to the rib 523 at the valve seat member 52 until controlled by the lower end. The outer circumferential surface of the valve 511 at the valve member 51 contracts and there is separation from the inner wall 522 of the valve seat member 52. Because of this, there is a possibility, for the inflow valve structure 50, in this open state, to have flow of the fluid between the inside and the outside of the container main body 10.

When the pressure, for this outflow valve structure 60, which is directed to the outside from the inside of the container main body 10, is eliminated, or when the pressure is directed to the inside from the outside is biased, as shown in once again FIG. 5(a), the outer circumferential part of the valve 511 on the valve member 51 expands, and makes contact with the inner wall 522 of the valve seat member 52. From this, the inflow valve structure 50 once again prohibits passage of the fluid between the inside and the outside of the container main body 10. The slide part 513 on the valve member 51 moves relatively to the inside of the container main body 10 with respect to the rib 523 on the valve seat member 52.

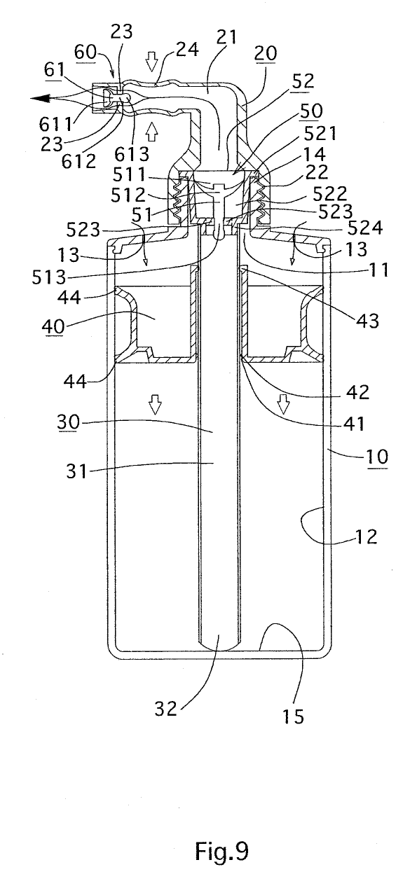

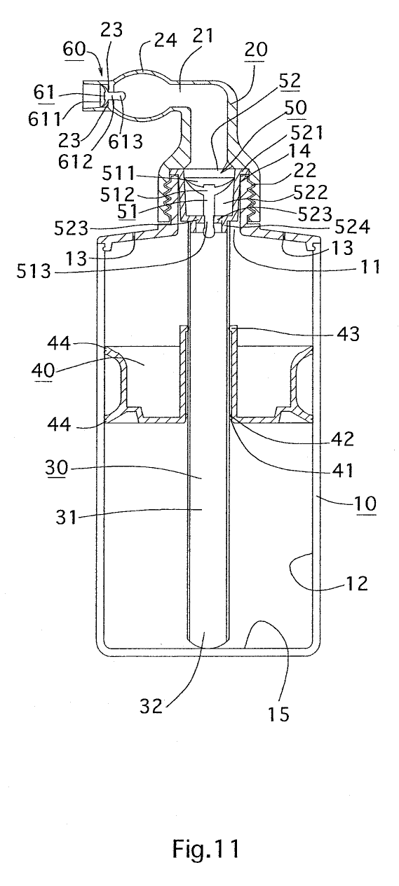

FIGS. 9-11 are vertical cross-sectional views of the fluid storage container which shows the states during which there is discharge of the fluid which was stored inside the container main body 10 for this kind of fluid storage container.

When there is discharge of the fluid which was stored inside the container main body 10 for this kind of fluid storage container, as shown in FIG. 9, there is pressure on the expansion part 24 on the discharge member 20. From this, inside the flow path 21 at the discharge outlet member 20, pressure is added. Because of this, the inflow valve structure 50 receives a pressure that is directed to the inside from the outside of the container main body 10. In addition, the outflow valve structure 60 receives a pressure that is directed to the outside from the inside. From this, the outflow valve structure 60 opens, and the fluid that was stored between the inflow valve structure 50 and the outflow valve structure 60 at the discharge outlet member 20 flows out to the outside.

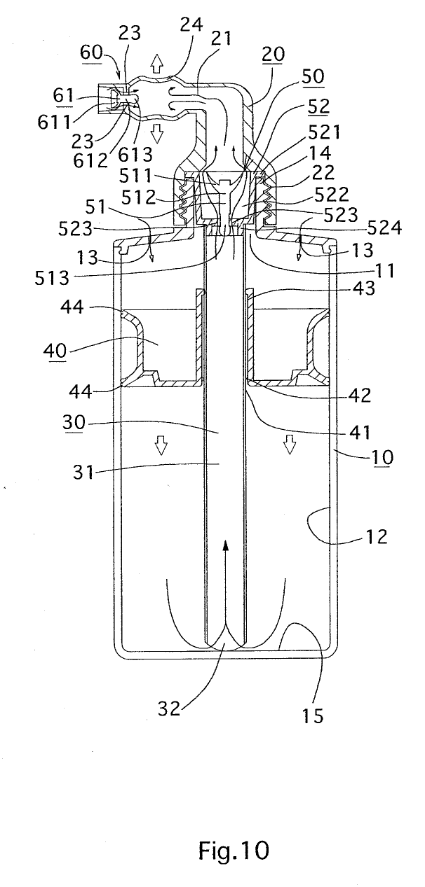

If the appropriate amount of fluid has flown out, as shown in FIG. 10, there is a limitation of the pressure of the expansion part 24 on the discharge outlet member 20. From this, there is a reduction in pressure on the inside of the fluid path 21 at the discharge outlet member 20. Because of this, the inflow valve structure 50 receives a pressure directed to the outside from the inside of the container main body 10. From this, the inflow valve structure 50 opens, and the fluid that was stored in this space that was formed between the base of the container main body 10 and the piston member 40 by means of the flow path 31 of the tube member 30 flows in to the inside of the flow path 21 at the discharge outlet member 20. In addition, the outflow valve structure 60 receives a pressure directed to the inside from the outside. From this, the outflow valve structure 60 moves from an open state to a closed state. At this time, because inside the flow path 21 at the discharge outlet member 20 experiences a reduction in pressure, it becomes possible to drag into the inside of the flow path 21 at the discharge outlet member 20 the fluid that remained in the vicinity of the outflow valve structure 60.

The fluid that was stored in the space that was formed between the base of the container main body 10 and the piston member 40 is reduced. Because of this reduction, the piston member 40 moves in the direction of the base of the container main body 10. Following this, the space that was formed between the opening 11 of the main container 10 and the piston member 40 expands. Because of this, outside air from the aeration hole that was drilled in the main container 10 flows in.

The above described operation is completed and if the pressure relationship at the same level exists mutually between any members, as shown in FIG. 1, the inflow valve structure 50 and the outflow valve structure 60 become closed, and also the movement of the piston member 40 stops, and the flow in of outside air from the aeration hole 13 stops.

In an embodiment, the cylinder section 12 may have a slightly tapered inner wall having a narrower inner diameter on its top than at its bottom, so that the piston member 40 can move more easily toward its bottom than toward its top. In the above embodiment, the bottom section may be formed separately from the cylinder section and then attached to the bottom of the cylinder section (instead of integral formation with the cylinder section), so that the cylinder section having the tapered inner wall can easily be made.

For the fluid storage container in Embodiment 1 of this invention, with this kind of structure, the piston member as with a conventional fluid storage container does not experience the gravity of the fluid, and there is no problem of the fluid from the piston member leaking and flowing out.

Next, there's an explanation of another embodiment of this invention based on the drawings. Moreover, a detailed explanation is omitted by attaching the same symbols for the same members that existed with the above described Embodiment 1.

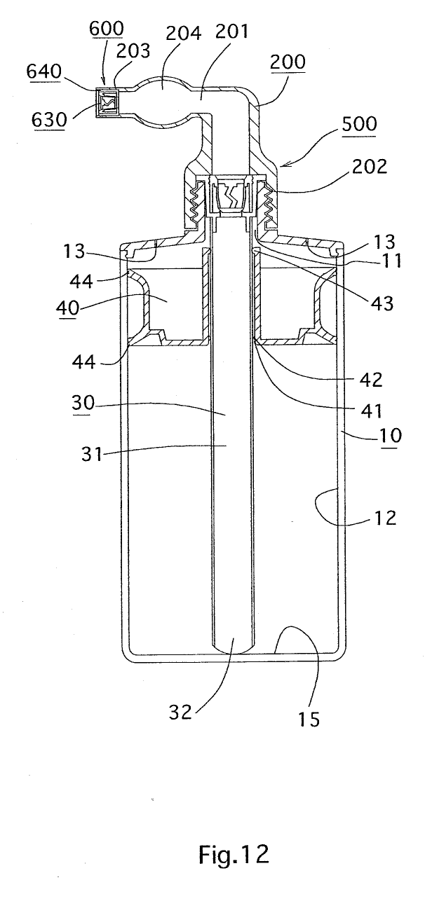

FIG. 12 is a vertical cross-sectional diagram which shows a fluid storage container related to Embodiment 2 of this invention.

The fluid storage container that is related to Embodiment 2 of this invention substitutes for the discharge outlet member 20, the inflow valve structured 50, and the outflow valve structure 60 for the fluid storage container that is related to Embodiment 1, the discharge outlet member 200, the inflow valve structure 500, and the outflow valve structure 600. These substituted elements are what make Embodiment 2 different from Embodiment 1.

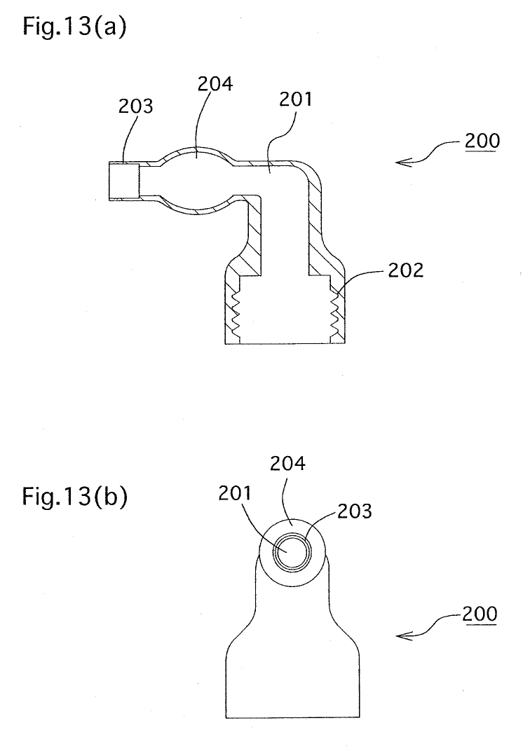

FIG. 13 is an explanation diagram which shows the discharge outlet member 200. In these diagrams, FIG. 13(a) is a vertical cross-sectional diagram of the discharge outlet member 200, and FIG. 13 (b) is the left side surface view.

The discharge outlet member 200 is formed from an elastic number which has the flow path 201 for flowing out to the outside fluid that was stored in the container main body 10. A male thread 202 is formed at the side of the container main body 10 of the flow path 201 at this discharge outlet member 200. This male thread 202 threads together with the male thread 14 which was formed on the outside of the opening 11 of the container main body 10. In addition, to join 203 which joins with the valve seat member 640 which forms the inflow valve structure 600 which is later described in detail is formed at the discharge and the fluid of the flow path 201 at this discharge outlet member 200. Furthermore, an expansion part 204 is formed between the male thread 202 and the join 203 of the flow path 201 at this discharge outlet member 200. This expansion element 204 is closely formed. From this, there is contraction of the width of the flow path 201 from outside pressure, and it is possible to reduce the pressure inside the flow path 21 by the elastic restoring force the discharge outlet member 21 when eliminating the pressure from the outside.

The outflow valve structure 600 is formed by the valve seat member 640 and the valve member 630.

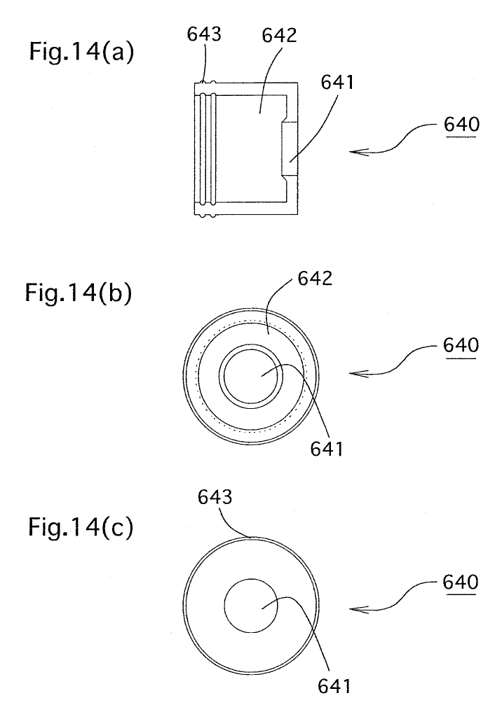

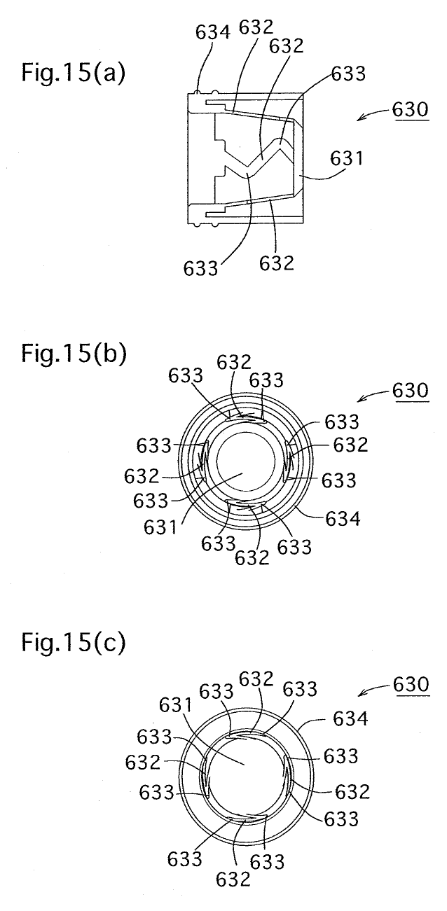

FIG. 14 is an explanation diagram which shows the valve seat member 640 which forms the outflow valve structure 600. Among these diagrams, FIG. 14(a) is a vertical cross-sectional view of the valve member 640, and FIG. 14 (b) is its left side surface view. In addition, FIG. 14 (c) is its right side surface view.

The valve seat member 640 which provides a hole 641 is formed with a shape that corresponds with the valve 631 of the valve member 630 which is later explained in detail, and a hollow tubular-shaped join which joins with the support 634 of the valve member 630, and a convex element 643 for connecting with the join 203 of the discharge outlet member 200.

The valve member 630 provides a valve 631 which is connectable with the outline of the hole 641 of the valve seat member 640, a support 634 which joins with the join 642 of the valve seat member 640, and 4 linking elements 632 which link together the valve 631 and the support 634. These 4 linking elements, respectively, have good elasticity and flexibility from a pair of bending elements 633.

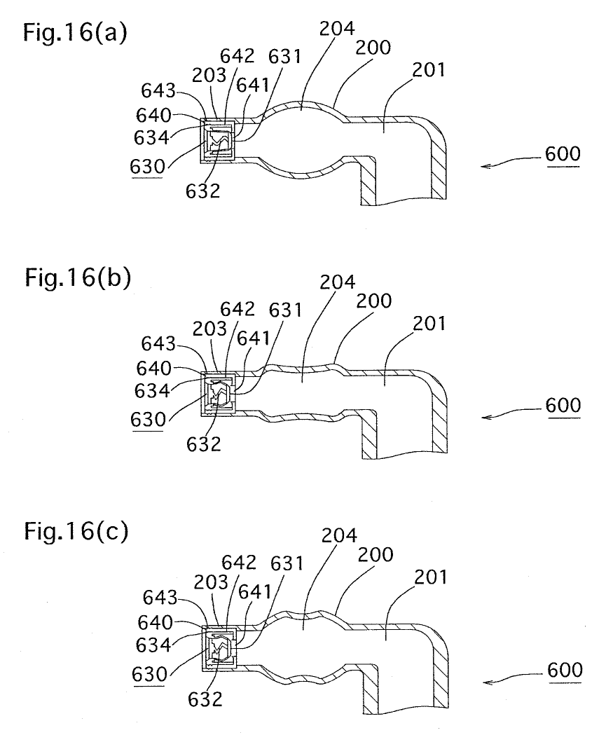

FIG. 16 is an explanation diagram which shows the outflow valve structure 600. Among these diagrams, FIG. 16(a) shows the close state of the outflow valve structure 600, FIG. 16 (b) shows the open state, and FIG. 16 (c) shows the state while returning to a closed state from an open state.

The outflow valve structured 600, as described above, is formed from the valve seat member 640 and the valve member 630. When this outflow valve structure 600 spontaneously releases, as shown in FIG. 16 (a), the valve 631 for the valve member 630 becomes closed which makes a connection with the outline of the hole 641 at the valve seat member 640. The outflow valve structure 600 does not allow flow of the fluid between the inside and the outside in this closed state.

When there is pressure for this outflow valve structure 600 that is biased to the outside from the inside, as shown in FIG. 16(b), the valve 631 for the valve member 630 separates from the hole 641 at the valve seat member 640 until controlled by the linking element 632. Because of this, it is possible, for the outflow valve structure 600, in the open state, to flow fluid between the inside and the outside.

When the pressure for this outflow valve structure 600 from the inside to the outside is cancelled, or when the compression force is biased from the outside to the inside, as shown in FIG. 16 (c), the valve 631 by the elasticity or flexibility of the linking elements 632 for the valve member 630 joins with the outline of the hole 641 at the valve seat member 640. From this joining, the outflow valve structure 600 once again, in this state, makes impossible the flow between the inside and the outside.

Moreover, it is desirable to form as a single body the valve seat member 640 which forms the outflow valve structure and the discharge outlet member 200. In this case, because it is possible to reduce the structure parts, it is possible to reduce the manufacturing costs and manufacturing processes.

The flow in structure 500 is formed by the valve seat member 540 and the valve member 530.

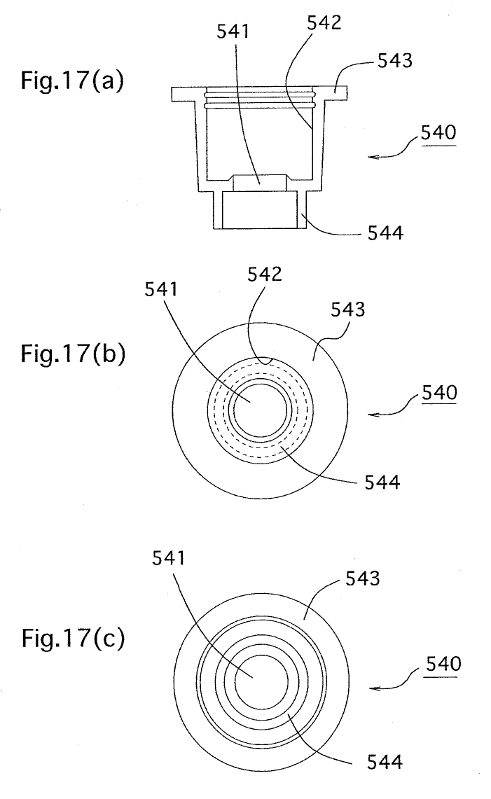

FIG. 17 is an explanation diagram which shows the valve seat member 540 which forms the flow in structure 500. Among these diagrams, FIG. 17(a) is a vertical cross-sectional diagram of the valve seat member 540 and FIG. 17 (b) is the top surface view. In addition, FIG. 17 (c) is a base surface view.

The valve seat member 540 provides a hole 541 which is formed as a shape which corresponds to the valve 531 of the valve member 530 which is later described in detail, a hollow shaped tubular join element 542 for joining with the support 534 of the valve member 530, the join element 543 for fixing to the discharge outlet member 200 and sandwiching between the container main body 10 and the discharge outlet member 200, and the join element 544 which connects with the upper end of the tube member.

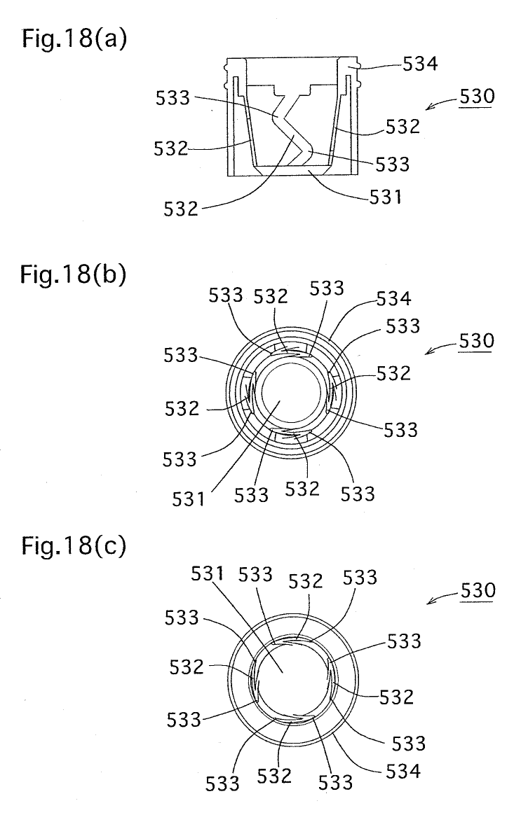

FIG. 18 is an explanation diagram which shows the valve member 530 which forms the inflow valve structure 500. Among these diagrams, FIG. 18(a) is a vertical cross-sectional diagram of the valve member 530 and FIG. 18 (b) is a top surface view. In addition, FIG. 18 (c) is a base surface view.

Valve member 530 provides the valve 531 which can make contact with the outline of the hole 541 of the valve seat member 540 and support 534 which joins with the join element 542 of the valve seat member 540, and the four linking elements 532 which link the valve 531 and the support 534. These four linking elements 532 have good elasticity and flexibility from a pair of bending elements 533.

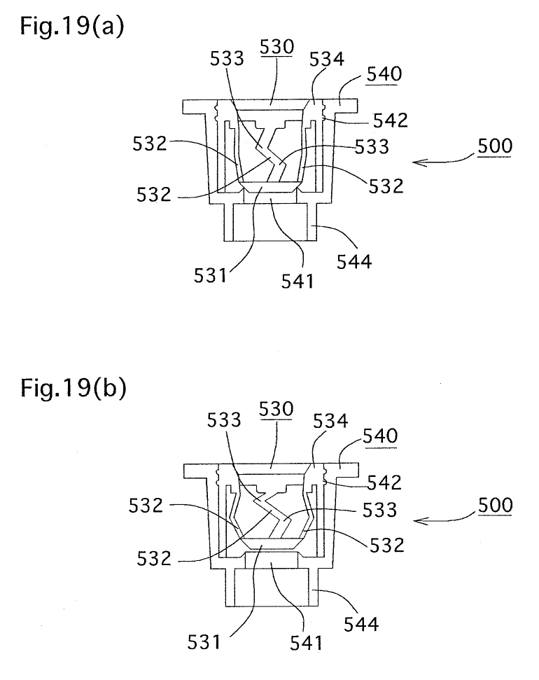

FIG. 19 is an explanation diagram which shows the inflow valve structure 500. Among these diagrams, FIG. 19 (a) shows the closed state for the inflow valve structure 500 and FIG. 19 (b) shows the closed state.

The inflow valve structure 500 is formed by the valve seat member 540 and the valve member 530. When there is spontaneous release of this inflow valve structure 500, as shown in FIG. 19 (a), the valve 531 on the valve member 530 becomes closed making contact with the outline of the whole 541 of the valve seat member 540. The inflow valve structured 500, in this closed state, prohibits flow of fluid between the inside and the outside.

When the pressure for this inflow valve structure 500 is biased to the outside from the inside, as shown in FIG. 19 (b), valve 531 of the valve member 530 separates from the hole 541 on the valve member 540 until controlled by the linking elements 532. Because of this, there is the possibility for the inflow valve structure 500 to have flow of fluid between the inside in the outside in the open state.

When the pressure for this inflow valve structure 500 from the inside to the outside is canceled, or when the pressure is biased to the inside from the outside, as once again shown in FIG. 19 (a), the valve 531 makes contact with the outline of the hole 541 on the valve seat member 540 from the elasticity or flexibility of the linking elements 532 on the valve member 530. From this, the inflow valve structure 500, in this state, once again prohibits flow of fluid between the inside in the outside.

For this kind of fluid storage container which is related to Embodiment 2, when there is discharge of the fluid that is stored within the container main body 10, in the same way for the fluid storage container which is related to Embodiment 1, there is pressure on the expansion part 204 on the discharge outlet member 200. From this, the fluid that was stored between the inflow valve structure 500 and outflow valve structure 600 at the discharge outlet member 200 flows out to the outside. If an appropriate amount of flow of the fluid has been completed, there is cancellation of the pressure for the expansion element 204 at the discharge outlet member 200. From this, the inflow valve structure 500 becomes open, and the fluid that was stored in the space that was formed between the base of the container main body 10 and a piston member 40 by means of the flow path 31 of the tube member 30 flows into the inside of the flow passage 201 at the discharge outlet member 200.

In addition, the outflow valve structure 600 receives a pressure to the inside from the outside. From this, the outflow valve structure 60 moves to a close condition from an open condition. At this time, because within the flow passage 201 at the discharge outlet member 200 there is a reduction in pressure, it becomes possible to drag the fluid which remains in the vicinity of the outflow valve structure 600 to the inside of the flow path 201 at the discharge outlet member 200. The fluid that was stored in the space that was formed between the base of the container main body 10 and a piston member 40 is reduced. Because of this, the piston member 40 moves in the direction of the base of the container main body 10. Following this, the space that is formed between the opening 11 of the main container 10 and a piston member 40 expands. Because of this, air enters from the aeration hole 13 which was drilled in the container main body 10.

For the fluid storage container which is related to Embodiment 2 of this invention, in the same way as with the fluid storage container in Embodiment 1, as with conventional fluid storage containers, the piston member does not receive the gravity of the fluid, and there results no problem with the fluid from the piston member leaking and flowing out.

Moreover, the fluid storage container may be formed so as not to provide inflow valve structures 50, 500 for the fluid storage container which is related to Embodiment 2 and Embodiment 1 both described above. At this time, there is pressure on the expansion element 24 at this fluid storage container. From this, there is added pressure on the inside of the flow path 21 at the discharge outlet member 20, on the inside of the flow path 31 for the tube member 30, and within the space that is formed between the base of the container main body 10 and piston member 40. Because of the outflow valve structure 60 or the outflow valve structure 600 there is received pressure from the inside to the outside. From this, the outflow valve structure 60 or the outflow valve structure 600 becomes open, and the fluid that remained in the flow path 20 of the discharge outlet member 20 flows out to the outside.

Afterwards, if an appropriate amount of fluid has flowed out, pressure on the expansion element 24 for this fluid storage container is canceled. From this, there is a reduction in pressure inside the flow path 21 at the discharge outlet member 20, inside the flow path 31 for the tube member 30, and within the space that was formed between the base of the container main body 10 and the piston member 40. Because of this, the outflow valve structure 60 or the outflow valve structure 600 receives pressure directed from the outside to the inside. From this, the outflow valve structure 60 or the outflow valve structure 600 moves to a closed state from an open state. At this time, because there is a reduction in pressure inside the flow path 21 at the discharge outlet member 20, it is possible to drag the fluid that remains in the vicinity of the outflow valve structure 60 or the flow of valve structure 600 and the flow path 21 at the discharge outlet member 20.

In addition, because inside the flow path 21 at the discharge outlet member 20 there is pressure reduction, the piston member 40 moves in the direction of the base of the container main body 10. Following this, the space that is formed between the opening 11 of the container main body 10 and the piston member 40 expands. Because of this, outside air enters from the aeration hole 13 that was drilled in the container main body 10. The operation described above finishes, and if there results pressure relationships mutually between any members, once again the outflow valve structure 60 or the outflow valve structure 600 enter a closed state and movement of the piston member 40 stops, and the flow of outside air from the aeration hole 13 stops

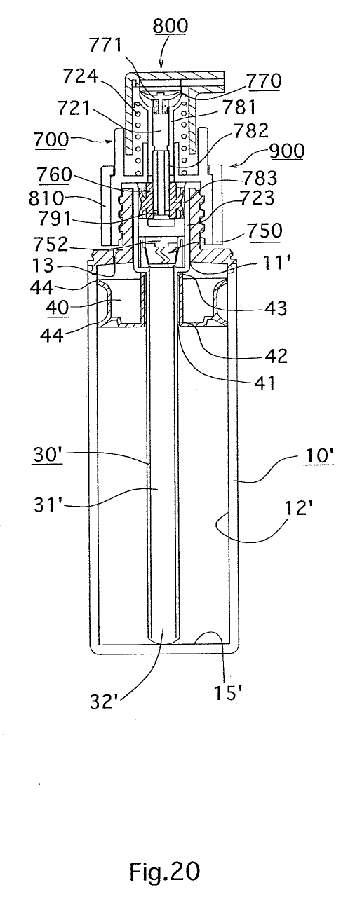

FIG. 20 is a vertical cross-sectional diagram which shows the fluid storage container which is related to Embodiment 3 of this invention.

With the fluid storage container which is related to Embodiment 3 of this invention there are substitutions for the discharge outlet member 20, the inflow valve structure 50, and the outflow valve structure 60 which formed the fluid storage container which is related to Embodiment 1, namely, the discharge outlet member 700, the fluid discharge pump 900, the nozzle head 800, and the outside cover 810. These are the only differences between Embodiment 1 and Embodiment 3.

The discharge outlet member 700 with the fluid discharge pump 900 which forms the fluid storage container which is related to Embodiment 3 is established on the inside of the open part 11′ of the container main body 10′. The piston member 40 is installed inside the cylinder section 12′. For this discharge outlet member 700 with the fluid discharge pump 900, there is provided hollow 1^{st} and 2^{nd} linked pipes 781 and 782 which are linked and fixed mutually which form a linking pipe for lowering the piston 783 by transmitting to the piston 783 a pressure which is imparted to the nozzle head 800 by linking the cylinder 723 which the lower terminal opening connects with the tube member 30′, and by linking the restorable and moveable piston 783 within the cylinder 723, and the nozzle head 800 and the piston 783, and there is provided also a coil spring 724 which is established on the outer circumference of the 1^{st} and 2^{nd} linked pipes 781 and 782 for biasing in the direction of raising the piston 783, a flow in structure 750 for flowing in to the inside of the cylinder 723 the fluid that remained in the container main body 10′ by following the rise motion of the piston 783 by means of the tube member 30′, and an intermediate valve structure 760 for opening and closing the opening part 791 for flowing in to the inside of the 1^{st} and 2^{nd} linked pipes 781 and 782 the fluid which has flowed inside the cylinder 723 by following the downward operation of the piston 783, and finally there is provided an outflow valve structure 770 for flowing out to the discharge outlet of the nozzle head 800 of fluid which had flowed in to the inside of the 1^{st} and 2^{nd} linked pipes 781 and 782. In this embodiment, a flow passage 721 is formed inside the linked pipes 781 and 782 and the cylinder 723.

The inflow valve structure 750 is formed from a lower end opening which is formed at the lower end of the cylinder 723, from the valve which is formed into a shape which corresponds with the lower end opening of the cylinder 723, from the support which joins with the cylinder 723 and from the valve member 751 of resin manufacture which has 4 linking elements which have elasticity and flexibility which link the valve and the support. Because of this, the inflow valve structure 750, when there is pressure added inside the cylinder 723, along with the valve, through elasticity or flexibility of the linked elements closes the lower end opening of the cylinder 723 by making contact with the lower end opening of the cylinder 723, and when the pressure is reduced inside the cylinder 723, the valve through elasticity or flexibility of the linked elements opens the lower end opening of the cylinder 723 by separating from the lower end opening of the cylinder 723.

The intermediate valve structure 760 is formed by the piston 783 and the 2^{nd} linked pipe 782. The piston 783 is established on the 2^{nd} linked pipe 782 so as to be slidable between the connector with the 1^{st} linked pipe 78 in the 2^{nd} linked pipe 782 and the lower end of the 2^{nd} linked pipe 782. Because of this, for the intermediate valve structure 760, when the hollow inside which is made between the lower end opening of the cylinder 723 in the piston 783 experiences added pressure, along with the lower end of the piston 783 releasing the opening 791 by moving to a position which makes contact with the 1^{st} linked pipe 781 and the connector on the 2^{nd} linked pipe 782, and when the hollow inside which is formed between the lower end opening of the cylinder 723 in the piston 783 experiences reduced pressure, the lower end of the piston 783 closes the opening 791 by moving to a position which connects with the lower end of the 2^{nd} linked pipe 782.

The outflow valve structure 770 is formed by a resin manufactured valve member 771 which has a plurality of supports which are established from bowl-shaped valves which are formed as shapes which correspond to the upper end opening of the 1^{st} linked pipe 782 and the upper end opening of the 1^{st} linked said 782 and from valves. Because of this, when, for the outflow valve structure 770, the insides of the 1^{st} and 2^{nd} linked pipes 781 and 782 experience added pressure, the plane surface maximum surface area of the bowl-shaped valves contracts and along with an opening of the upper end of the 1^{st} linked pipe 782, when the insides of the 1^{st} and 2^{nd} linked pipes 781 and 782 experience a reduction in pressure, the plane maximum surface area of the bowl-shaped valves expands, and the upper end of the 1^{st} linked pipe 782 closes.

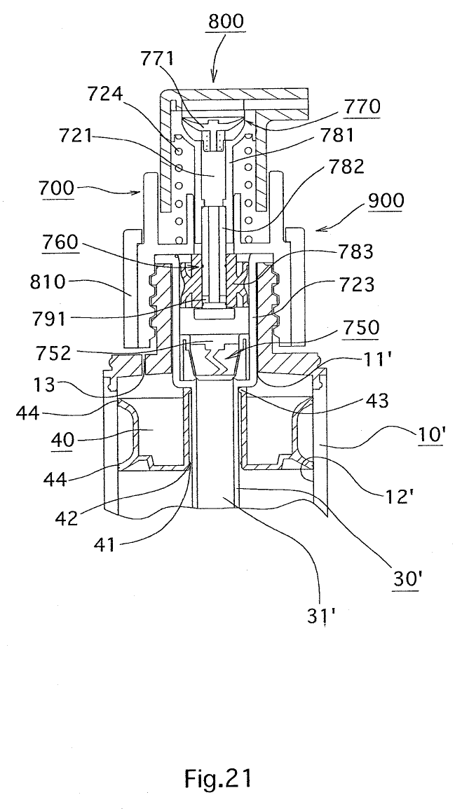

FIGS. 21-23 are vertical cross-sectional diagrams of the discharge outlet member 700 with the fluid discharge pump 900 which show the discharging conditions of the fluid that is stored within the container main body 10′ which forms the fluid storage container which is related to Embodiment 3.

For this fluid discharge pump 900, when in a condition where there is spontaneous release, the valve structure 750, the intermediate valve structure 760 and the outflow valve structure 770 become closed.

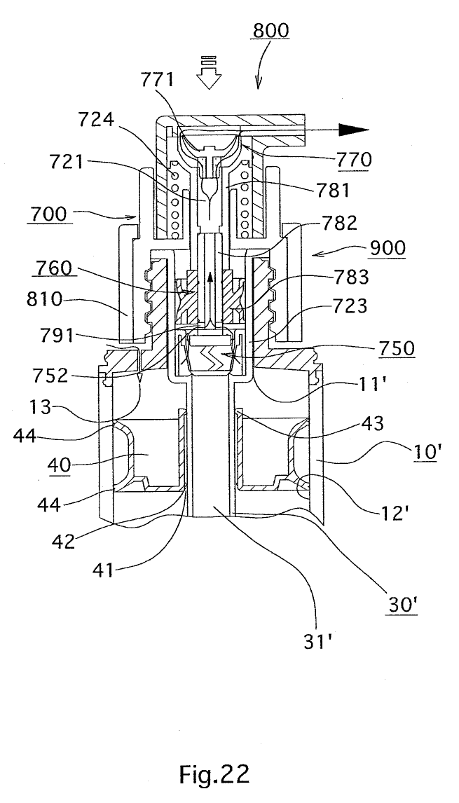

When there is discharge of the fluid from this fluid discharge pump 900, first, as shown in FIG. 22, there is imparted a pressure to the nozzle head 800. When there is imparted a pressure to the nozzle head 800, there is resistance to the biasing force of the coil spring 824, and the nozzle head 800 falls. At this time, the piston 783 following the falling movement of the nozzle head 800 falls. In this way, when piston 783 falls, inside the space that was formed between the lower end opening of the cylinder 723 and the piston 783 experiences added pressure. When inside the space that was formed between the lower end opening of the cylinder 723 and the piston 783 experiences added pressure, the upper end of the piston 783 on the intermediate valve structure 760 opens the opening 791 by moving to a position which makes contact with the join of the 1^{st} linked pipe on the 2^{nd} linked pipe. From this, the fluid which was stored inside the space that was formed between the lower end opening of the cylinder 823 and the piston a role 783 flows inside the 1^{st} and 2^{nd} linked pipes 781 and 782. In this way, when there is flow in to the inside of the 1^{st} and 2^{nd} linked pipes 781 and 782, inside the 1^{st} and 2^{nd} linked pipes 781 and 782 experience added pressure. When the inside the 1^{st} and 2^{nd} linked pipes 781 and 782 experience increased pressure, the plane maximum surface area of the bowl-shaped valve in the outflow valve structure 770 contracts, and there is opening of the upper end opening of the 1^{st} linked pipe 782. The fluid, which flowed into the 1^{st} and 2^{nd} linked pipes 781 and 782, flows out to the discharge opening of the nozzle head.

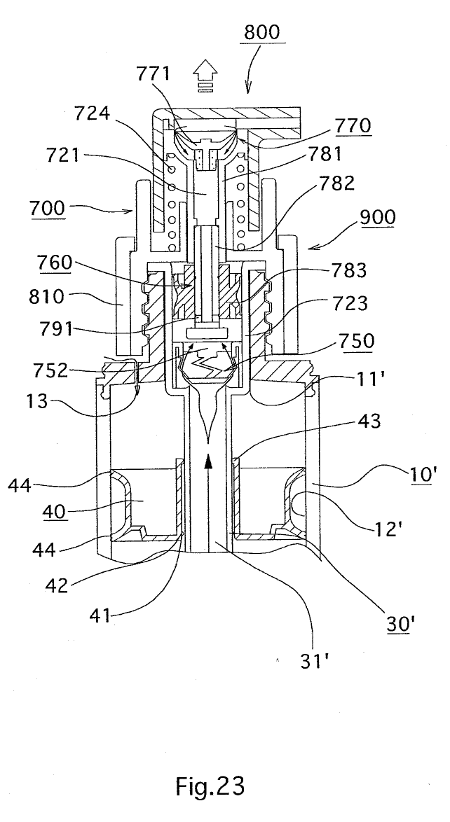

When there is cancellation of the pressure on the nozzle head 800, as shown in FIG. 23, the nozzle head 800 rises from the elastic restoring force of the coil spring 724. At this time, the piston 783 rises following the rising operation of the nozzle head 800. In this way, when the piston 783 rises, the hollow inside which was formed between the lower end opening of the cylinder 723 and the piston 783 experiences a reduction in pressure. When the hollow inside which was formed between the lower end opening of the cylinder 723 and the piston 783 experiences a reduction in pressure, there is closing of the opening 791 by moving to a position at which the lower end of the piston 783 for the intermediate valve structure 760 makes contact with the lower end of the 2^{nd} linked pipe 782. From this, the inside of the 1 and 2^{nd} linked pipes 781 and 782 does not experience any increased pressure. When the inside of the 1^{st} and 2^{nd} linked pipes 781 and 782 does not experience any increased pressure, the plan maximum surface area of the bowl-shaped valve in the outflow valve structure 770 expands, and the upper end opening of the 1^{st} linked pipe closes. In addition, when the hollow inside which is formed between the lower end opening of the cylinder 723 and the piston 783 experiences a reduction in pressure, the value, through the elasticity or flexibility of the link with the inflow valve structure 750, closes the lower end opening of the cylinder 723 by separating from the lower end opening of the cylinder 723. The fluid which was stored within the container main body 10′ between the piston member 40 and the bottom section 15′ flows into the inside of the cylinder 723 through the flow path 31′ of the tube member 30′ via the lower end 32′.

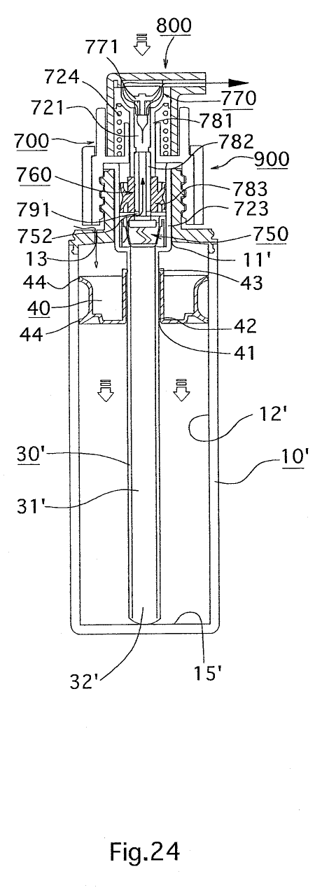

FIGS. 24-26 are vertical cross-sectional diagrams of the fluid storage container which shows the condition for discharge in the fluid that was stored inside the container main body 10 for the fluid storage container which is related to Embodiment 3.

When there is discharge of the fluid that was stored inside the container main body 10′ for the fluid storage container which is related to Embodiment 3, as shown in FIG. 24, pressure is imparted to the nozzle head 800. From this, the outflow valve structure 770 in the fluid discharge pump 800 enters an open state, and fluid flow from the discharge opening of the nozzle head 800.

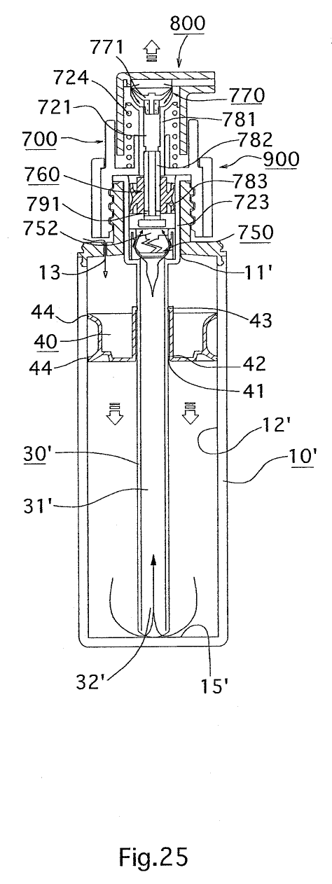

When a sufficient amount of fluid has flowed out, as shown in FIG. 25, there is cancellation of the pressure on the nozzle head 800. When there is cancellation of the pressure on the nozzle head 800, along with the outflow valve structure 770 entering a closed state, the inflow valve structure 750 enters an open state, and the fluid that was stored in the space between the base of the container main body 10′ in the piston member 40 flows into the cylinder 723 by means of the tube member 30′. From this, inside the flow path 31′ in the tube member 30′, and inside the space is formed between the base of the container main body 10′ and the piston member 40 there is experienced reduced pressure. Because of this, the piston member 40 moves in the direction of the base of the container main body 10′.

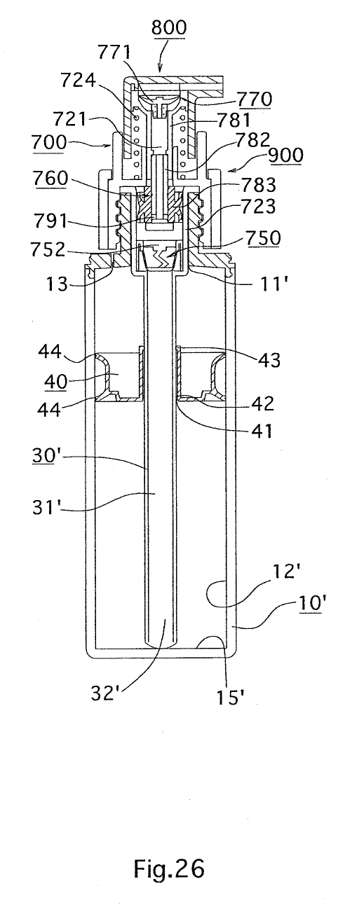

When the piston member 40 moves in the direction of the base of the container main body 10, as shown in FIG. 26, the space that is formed between the opening element 11 of the container main body 10 and the piston member 40 expands. From this, outside air enters from an aeration hole which was drilled into the container main body 10.

The above described operation finishes, and if there are the pressure relationships of the same degree among all mutual members, once again as shown in FIG. 22, the inflow valve structure 750 enters a closed state, movement of the piston member 40 stops, and the flow in also of outside air from the aeration hole 13 stops.

From this kind of formation for the fluid storage container which is related to Embodiment 3 of this invention, the piston member does not receive gravity of the fluid as with conventional fluid storage containers, and there is no generation of problems such as fluid leakage from the piston member.

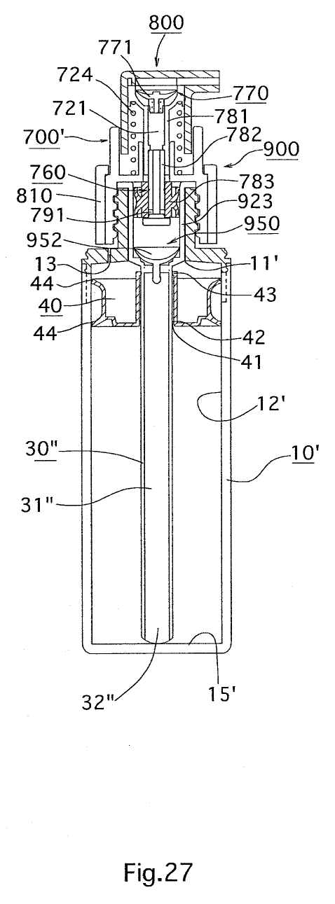

FIG. 27 is a vertical cross-sectional diagram which shows the fluid storage container which is related to Embodiment 4 of this invention.

The fluid storage container which is related to Embodiment 4 of this invention provides the discharge outlet member 700′ in place of the discharge outlet member 700 which formed the fluid storage container which is related to Embodiment 3, and it is at this point where the Embodiment 4 differs from the Embodiment 3.

The discharge outlet member 700′ including the fluid discharge pump 900 which forms the fluid storage container which is related to Embodiment 4 substitutes for the cylinder 723 and the inflow valve structure 750 in the discharge outlet member 700 which formed the fluid storage container which is related to Embodiment 3, and there is provided the cylinder 923 and the inflow valve structure 950. A plurality of ribs is formed in the vicinity of the lower end opening of the cylinder 923.

The inflow valve structure 950 is formed from the rib part which was formed in the cylinder 923 and the lower opening and the valve member 952.

The valve member 952 is formed from an elastic member which provides an approximate bowl-shaped valve whose outer circumferential surface can connect with the lower end opening of the cylinder 923, an axis which is established from the approximate center of the valve, and a slidable part which supports slidably the rib part of the cylinder 923 by being located at the approximate center of the axis.

The valve in the valve member 952 is closely formed. Because of this, the outer circumferential surface contracts when there is a biasing pressure from the bottom to the top, and there is separation from the lower end opening of the cylinder 923. On the other hand, when the pressure from the bottom to the top is cancelled, or the pressure is biased from the top to the bottom, this outer circumferential surface is restored or expands, and there is a connection with the lower end opening of the cylinder 923.

The slidable part is formed to give a slidable shape to the rib which is formed on the cylinder 923. The sliding motion for the rib of this slidable part is controlled by the lower and upper ends of the slidable part.

In this embodiment, because the valve member 952 is different from the valve member 752 in the previous embodiment, the tube member 30″ has a slightly different configuration than the tube member 30′ in the previous embodiment. In both embodiments, the tube member 30′, 30″ are integrally formed with the cylinder 723, 923, respectively. The flow pass 31″ is formed inside the tube member 30″ which has the lower end 32″, as in the previous embodiment.

When there is discharge of the fluid that has been stored inside the container main body 10′ of the fluid storage container which is related to Embodiment 4, in the same way as for the fluid storage container which is related to Embodiment 3, there is imparted a pressure to the nozzle head 800. From this, the outflow valve structure 770 in the discharge outlet member 700′ enters an open state, and there is flow out of fluid from the discharge opening of the nozzle head 800.

When there is cancellation of the pressure on the nozzle head 800, along with the outflow valve structure 770 entering a closed state, the inflow valve structure 950 enters an open state, and the fluid that was stored inside the space that was formed between the base of the container main body 10′ and the piston member 40 flows in to the inside of the cylinder in 923 by means of the tube member 30″. From this, inside the flow path 31″ in the tube member 30″, and inside the space that is formed between the base of the container main body 10′ in the piston member 40 experiences reduced pressure. Because of this, the piston member 40 moves in the direction of the base of the container main body 10′.

When the piston member 40 moves in the direction of the base of the container main body 10′, the space that is formed between the opening parts 11 of the container main body 10′ in the piston member 40 expands. From this, the air outside enters from the aeration hole 13 that was drilled in the container main body 10′.

The above described operation finishes, and if the pressure relationships are of the same level among all mutual members, once again the inflow valve structure 950 enters a closed state, also the movement of the piston member 40 stops, and the flow in of external air from the aeration hole 13 stops.

From this kind of construction for a fluid storage container which is related to Embodiment 4 of this invention, there is no receipt by the piston member of the gravity of the fluid as with conventional fluid storage containers, and there is no problem with the leakage of fluid from the piston member.

Moreover, with the above described embodiments, all provide a piston member 40, but it is permissible to provide a piston member 70 in place of the piston member 40.

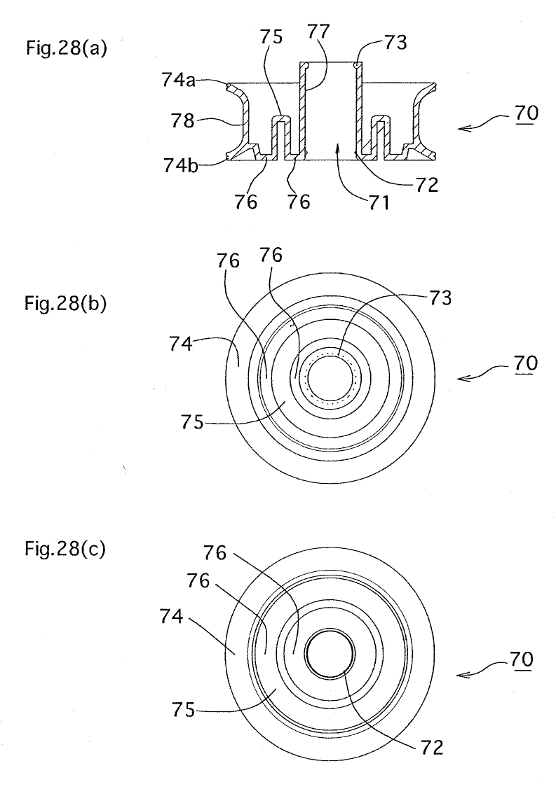

FIGS. 28(a)-28(c) are explanation diagrams which show the piston member 70. Among these diagrams, FIG. 28 (a) is a vertical cross-sectional diagram of the piston member 70 and FIG. 28 (b) is a top surface view. In addition, FIG. 28 (c) is a base surface view.

In the piston member 70, in the same way as with the piston member 40, there is formed a hole 70 which passes through the tube member 30″. The liquid tight parts 74a and 74b are formed on the upper and lower parts of the outer periphery 78 (outer circumferential surface) of this piston member 70 and are convex shaped which connect with the cylinder 12 of the container main body 10′. In addition, there is formed on the lower part of the inner periphery 77 forming the hole 71 of this piston member 70 a liquid tight part 72 of convex shape which connects with the tube member 30″, and on the upper part within the inner periphery 77 there is formed a liquid tight part 73 of convex shape which connects with the tube member 30″. The liquid tight part 73 of this upper part projects from the liquid tight part 72 of the bottom part. The liquid tight parts 72, 73, 74a, and 74b correspond to the liquid tight parts 42, 43, 44a, and 44b, respectively, and can have the configurations described with regard to the liquid tight parts 42, 43, 44a, and 44b. FIG. 33 shows a different embodiment wherein the piston member 70′ has the liquid tight parts 74a′ and 74b′ each constituted by a single convex portion.

This piston member 70, with a surface 76 perpendicular to the moving direction within the cylinder part 12 of the container main body 10′, is formed from elastic material for which a concentric circle shaped bending part 75 is formed concentrically with the outer periphery. Because of the surface 76 is formed at a lower end of the piston member 70, the lower end is less resilient than the upper end. However, in this embodiment, due to the bending part 75, the lower end can be effectively resilient.

Because of this, according to this piston member 70, the bending part 75 has a biasing force in the direction of the outer circumference, and even when there are changes in shape of the cylinder part 12 of the container main body 10′, it is possible to make liquid tight contact with the wall surface of the cylinder part 12 corresponding to these changes.

Moreover, for the above-mentioned embodiments, by making the base part of the container main body 100 and the base surfaces of the piston members 40 and 70 slanted to one another, it becomes possible to reduce residual fluid between the base part of the container main body 10′ and the base surface of the piston members 40 and 70.

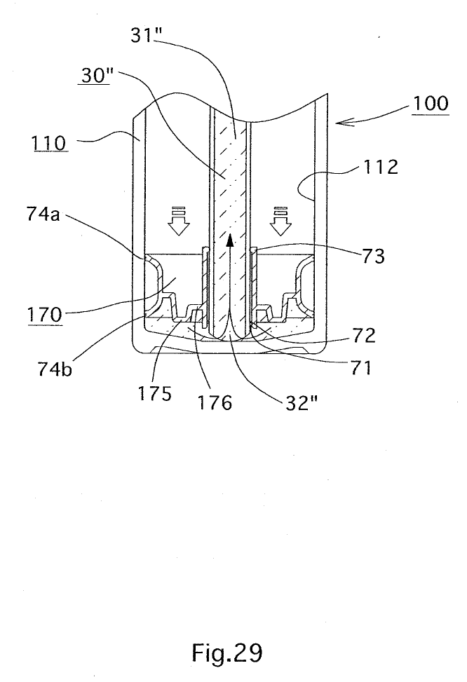

FIG. 29 is an explanation diagram which shows the base part of the container main body 100 when the base part of the container main body 100 and the base surface of the piston member 170 are slanted.

The base part of the container main body 100 which is shown in FIG. 29 is formed in an approximate hemispherical shape. By forming an approximate hemispherical shape for the base part in this way, fluid remains by being concentrated at the center. In this case, by forming a lower end of the hole 71 of the piston member 170, a concentric bending part 175 formed in a surface 176, and a liquid tight part 74b below, in a shape which is contactable at the same time with the base of the container main body 100, it becomes possible to lower the residual amount of the fluid between the container main body 100 and the piston member 170.

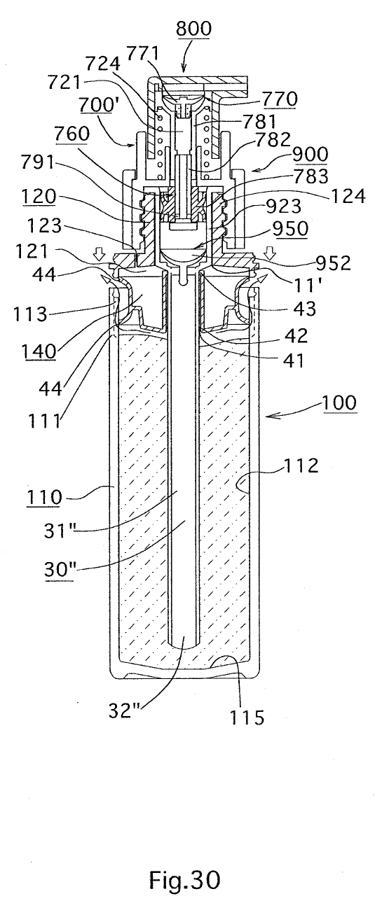

FIG. 30, for the fluid storage container which is related to Embodiment 5 of this invention, is an explanation diagram which shows the state of filling a fluid in the container main body 100 which has an upper end port 11 and a lower part 110 which is constituted by a cylinder section 112, and a bottom section 115.

With the fluid storage container which is related to Embodiment 5 there is provided a container main body 100 in place of the container main body 10 in the fluid storage container which is related to Embodiment 4. This is the point of difference between Embodiment 5 and Embodiment 4.

The container main body 100 in this fluid storage container provides a container with a lower part 110 of base tubular shape and a container upper part which is joinable at the upper end part 111 of the container lower part 110. Because of this, there is removed from the container lower part 110 of the container upper part 120 and the piston member 140, and it is possible to easily fill with fluid.

In the vicinity of the opening 121 of the container upper part 120, a plurality of aeration holes are drilled for drawing in from the outside air to this space which is formed between the opening part 121 of the container main body 100 and the piston member 140. In addition, on the outer circumference of the opening part 121, a male spring 124 is formed in order to join with the fluid discharge pump 900.

The container lower part 110 has the cylinder part 112 for sliding the end 111 and the piston member so as to join with the container upper end 120. A plurality of notches 113 is formed on the inside of the tube of this end 111. Because of this, as shown in FIG. 30, at the container lower end 110, and when the piston member 140 is held, it becomes possible to flow to the outside of the container lower part 110 by passage through the notches 113 air that has been entered between the fluid that filled the container lower part 110 and the piston member 140.

Moreover, in Embodiment 5, 113 is formed at the container lower part 110 but all the peripheral surfaces may be slanted with respect to the cylinder part 112 from the end part 111.

In addition, as explained above, there is assembly of the container main bodies 10, 10′, and 100, the discharge opening members 20, 200, 700, and 700′, the inflow valve structures 50, 500, 750, and 950, and the outflow valve structures 60, 600, and 770, and in addition it is possible to assemble by selecting any one of the piston members 40, 40′, 140, 70, 70′, and 170.

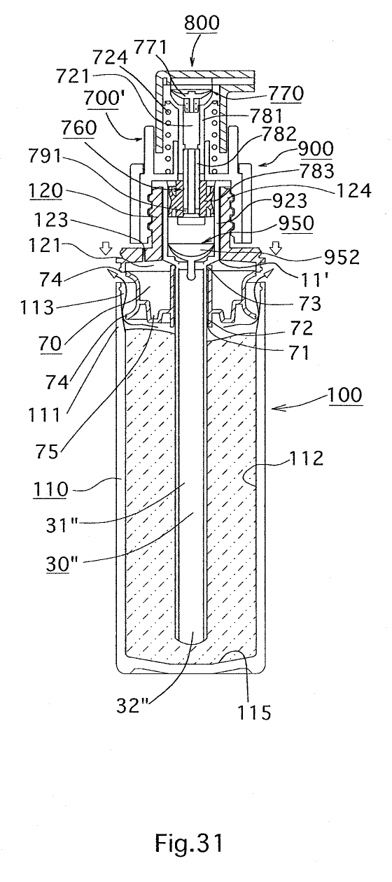

FIG. 31 is an explanation diagram which shows the fluid storage container that is assembled by selecting the container main body 100 and the piston member 70.

According to the fluid storage container which is shown in FIG. 31, even when there are changes in the shape of the cylinder part 112 of the container main body 100, along with being able to make liquid tight contact with the wall surface of the cylinder 112 which corresponds to this change, by filling the liquid in the container lower part 110, and when installing the piston member 70, it is possible to flow out to the outside of the container lower end 110 through a slanted surface of the end part 111 air that has entered between the fluid that filled in the container lower part 110 and the piston member 70.

The present invention includes the above mentioned embodiments and other various embodiments including the following:

1) A fluid storage container for which an opening section is formed on the top and a cylinder section is formed on the side surface and there is provided a container which stores fluid inside, and there is provided a discharge outlet member which is arranged at the opening section which is formed on the previously described container main body and has a flow passage for flowing out to the outside fluid which has been stored inside the previously described container, and there is a flow path which reaches the flow passage of the previously described discharge outlet member from the base of the previously described container main body, and there is provided a tube member which flows the fluid which was stored in the previously described container main body, and a hole is formed into which is inserted the previously described tube member, and there is provided a piston member which moves inside a cylinder in the previously described container main body, and there is storage of fluid in the space which is formed between the base of the previously described container body and the previously described piston member.

2) A fluid storage container as characterized in Item 1 wherein there is provided a valve structure on the inside of the previously described discharge outlet member.

3) A fluid storage container as characterized in Item 2 wherein there is provided on the inside of the previously described discharge outlet member, an inflow valve structure which flows in to the previously described flow passage fluid which was stored in the previously described container main body, and there is provided an outflow structure which flows out to the outside fluid which has flowed in to the previously described inflow valve structure.

A fluid storage container as characterized in Item 2 wherein there is provided on the inside of the previously described tube member an inflow valve structure which causes flow in to the inside of the previously described tube member fluid which has been stored on the previously described container main body, and provides, on the inside of the previously described discharge outlet, an outflow valve structure which flows to the outside fluid which has flowed in to the previously described inflow valve structure.

5) A fluid storage container as characterized in any one of Items 1-4 wherein the previously described piston member is formed from an elastic member whose concentric bending section is formed with the outer circumference on a perpendicular plane with the movement direction within the piston section of the previously described container main body, and the piston has a biasing force in the outer circumferential direction from the center.

6) A fluid storage container as characterized in Item 5 wherein the cylinder section in the previously described container main body has a taper shape which becomes a taper oriented in the direction of the previously described discharge outlet member.

7) A fluid storage container with an opening inlet section formed on the top and a cylinder formed on the side surface wherein there is provided a flow discharge pump which from pressure on a nozzle head which is arranged on the opening outlet section which is formed on the previously described container main body causes flow out from the previously described nozzle head fluid which was stored in the previously mentioned container main body, and having a flow path which reaches the previously described fluid discharge pump from the base of the previously described container main body, there is provided a tube member which causes flow of fluid which has been stored in the previously described container main body, and there is storage of fluid in the space that is formed between the base of the previously described container main body and the previously described piston member.

A fluid storage container as characterized as in any one of Items 1-7 wherein the previously described piston member is a convex section which makes contact with the previously described tube member at the hole section.

9) A fluid storage container as characterized in Item 8 wherein there is provided for the previously described piston member a 1^{st} convex section which makes contact with the previously described tube member at the bottom part of the hole section and a 2^{nd} convex section which projects from the previously described 1^{st} convex section to the top part of the hole section.

According to the embodiments of Item 1 and Item 7, because there is storage of fluid in this space that is formed between the base of the container main body in the piston member, along with preventing leaks of the fluid, it becomes possible to prevent contact with the outside air that enters inside the container main body.

According to the embodiment of Item 2, because there is provided a valve structure inside the discharge outlet member, it becomes possible to control the fluid output to the outside of the fluid that was stored within the container main body.

According to the embodiments of Item 3 and Item 4, because there is provided a fluid valve structure which enters into a flow passage fluid that was stored in the container main body, and an output valve structure which causes output flow to the outside of fluid that was entered by the inflow valve structure, along with controlling the output to the outside of the fluid that was stored within the container main body, it becomes possible to prevent the entry of outside air in the space that is formed between the base of the container main body and the piston member.

According to the embodiment of Item 5, because the piston member, for the surface perpendicular to the movement direction within the cylinder of the container main body, is formed from an elastic member whose concentric ending section is formed with the outer circumference and because there is a biasing force in the outer circumferential direction from the center, even when there are changes in the cylinder's diameter it is possible to maintain liquid density.

According to the embodiment of Item 6, because the cylinder section in the container main body has a taper shape which results from a taper oriented to the direction of the discharge of the member, it is possible to prevent the movement of the piston member in the direction of the discharge outlet member, and it is possible to prevent movement of the piston member in the direction of the discharge outlet member in the container main body.

According to the embodiment of Item 8, it is possible to prevent flow of the fluid which was stored in a space that was formed between the base of the container main body and the piston member, from flowing between the open section and the piston member of the container main body.

According to the embodiment of Item 9, even when there is an elastic restoring force for the piston member's top and bottom section, it is possible to prevent flow of the fluid that was stored in the space that was formed between the base of the container main body and the piston member into the space that was created between the open section of the container main body and the piston member.

The present application does not claim priority to but is based on Japanese Patent Application No. 2004-318072, filed Nov. 1, 2004, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A fluid storage container comprising:
a container main body for storing fluid inside comprised of an opening section formed on its top, a cylinder section formed on its side, and a bottom section;
a tube member immovably disposed inside the cylinder section and extending nearly from the bottom section to the opening section, inside which tube member constitutes a flow path for the fluid to flow therethrough via its lower end toward the opening section; and
a piston member disposed between the cylinder section and the tube member and being fluid-tightly slidable in an axial direction of the tube member toward the bottom section as the fluid between the piston and the bottom section outside the tube member moves into the tube member via the lower end of the tube member.

2. The fluid storage container according to claim 1, wherein the piston member has an inner periphery constituting a hole through which the tube member is fluid-tightly inserted, and an outer periphery fluid-tightly inserted in the cylinder section, said inner periphery and said outer periphery each having at least two fluid-tight portions.

3. The fluid storage container according to claim 2, wherein the at least two fluid-tight portions of the inner periphery comprise an upper fluid-tight portion arranged at an upper edge part of the inner periphery and a lower fluid-tight portion arranged at a lower edge part of the inner periphery; and the at least two fluid-tight portions of the outer periphery comprise an upper fluid-tight portion arranged at an upper edge part of the outer periphery and a lower fluid-tight portion arranged at a lower edge part of the outer periphery.

4. The fluid storage container according to claim 3, wherein each of the upper and lower fluid-tight portions of the inner periphery and the upper and lower fluid-tight portions of the outer periphery comprises at least one annular convex portion.

5. The fluid storage container according to claim 4, wherein the at least one annular convex portion constituting the upper fluid-tight portion of the inner periphery more protrudes inwardly than the at least one annular convex portion constituting the lower fluid-tight portion of the inner periphery.

6. The fluid storage container according to claim 2, wherein the inner periphery has a length in an axial direction of the tube member, which is greater than a length of the outer periphery in the axial direction.

7. The fluid storage container according to claim 2, wherein a lower edge of the outer periphery is less resilient in an inward radial direction perpendicular to an axial direction of the tube member than an upper edge of the outer periphery in the inward radial direction.

8. The fluid storage container according to claim 2, wherein the piston member is formed from an elastic member and has a lower surface facing the bottom section extending from the inner periphery to the outer periphery, said lower surface being defined on a plane perpendicular to an axial direction of the tube member and having at least one concentric bending portion to provide a biasing force in an outward radial direction toward the container main body.

9. The fluid storage container according to claim 1, wherein the piston member is slidable between the opening section and the bottom section.

10. The fluid storage container according to claim 1, wherein the piston member is fixed to no part of the fluid storage container in an axial direction of the tube member between the opening section and the bottom section.

11. The fluid storage container according to claim 1, further comprising a discharge outlet member arranged on the container main body at the opening section and having a flow passage connected to the flow path of the tube member for flowing the fluid inside the container main body out to the outside.

12. The fluid storage container according to claim 11, wherein an inflow valve structure for flowing the fluid from the tube member to the discharge outlet member is provided in the flow path or the flow passage.

13. The fluid storage container according to claim 12, wherein the inflow valve structure is arranged between the discharge outlet member and the tube member.

14. The fluid storage container according to claim 11, wherein the discharge outlet member comprises an outflow valve structure for flowing the fluid to the outside which is arranged downstream of the inflow valve structure.

15. The fluid storage container according to claim 14, further comprising a pumping mechanism disposed between the inflow valve structure and the outflow valve structure in the flow passage.

16. The fluid storage container according to claim 15, wherein the pumping mechanism comprises a reciprocally movable linking pipe and a piston coupled thereto in the flow passage for pumping the fluid from the tube member through the inflow valve structure out of the discharge outlet member through the outflow valve structure by reciprocal movement of the linking pipe and the piston.

17. The fluid storage container according to claim 15, wherein the pumping mechanism comprises an expansion part which is elastically deformable and restorable in the flow passage for pumping the fluid from the tube member through the inflow valve structure out of the discharge outlet member through the outflow valve structure by reciprocally deforming and restoring the expansion part.

18. The fluid storage container according to claim 1, wherein the cylinder section of the container main body has an upper edge part having cutouts extending toward its upper edge.

19. A piston member configured to be fluid-tightly disposed between a cylinder member and a tube member provided inside the cylinder member, comprising:
an inner periphery constituting a hole through which the tube member is to be fluid-tightly inserted; and
an outer periphery which is to be fluid-tightly inserted in the cylinder member,
said inner periphery and said outer periphery each having at least two fluid-tight portions, wherein the inner periphery has a length in an axial direction of the piston member, which is greater than a length of the outer periphery in the axial direction.

20. The piston member according to claim 19, wherein the at least two fluid-tight portions of the inner periphery comprise an upper fluid-tight portion arranged at an upper edge part of the inner periphery and a lower fluid-tight portion arranged at a lower edge part of the inner periphery; and the at least two fluid-tight portions of the outer periphery comprise an upper fluid-tight portion arranged at an upper edge part of the outer periphery and a lower fluid-tight portion arranged at a lower edge part of the outer periphery.

21. The piston member according to claim 20, wherein each of the upper and lower fluid-tight portions of the inner periphery and the upper and lower fluid-tight portions of the outer periphery comprises at least one annular convex portion.

22. The piston member according to claim 21, wherein the at least one annular convex portion constituting the upper fluid-tight portion of the inner periphery more protrudes inwardly than the at least one annular convex portion constituting the lower fluid-tight portion of the inner periphery.

23. The piston member according to claim 20, wherein a lower edge of the outer periphery is less resilient in an inward radial direction perpendicular to an axial direction of the piston member than an upper edge of the outer periphery in the inward radial direction.

24. The piston member according to claim 20, wherein the piston member is formed from an elastic member and has a lower surface facing the bottom section extending from the inner periphery to the outer periphery, said lower surface being defined on a plane perpendicular to an axial direction of the piston member and having at least one concentric bending portion to provide a biasing force in an outward radial direction.
